(19) United States
(12) Patent Application Publication
(10) Pub. No.: US 2026/0030776 A1
(43) Pub. Date: Jan. 29, 2026

(54) SPARSE COMPOSITION

(71) Applicant: QUALCOMM Incorporated, San Diego, CA (US)

(72) Inventors: Rakesh Raju CHENNA MADHAVUNI, San Diego, CA (US); Simon Peter William BOOTH, San Diego, CA (US); Wesley James HOLLAND, Encinitas, CA (US); Pawan Kumar BAHETI, San Diego, CA (US); Dam BACKER, San Diego, CA (US)

(21) Appl. No.: 19/160,009

(22) PCT Filed: Apr. 5, 2024
(86) PCT No.: PCT/US2024/023204

§ 371 Date: Aug. 26, 2025

(30) Foreign Application Priority Data
May 1, 2023 (IN) 202341031043
Jun. 5, 2023 (IN) 202321038422

(51) Int. Cl. G06T 7/73; G06F 16/58; G06T 7/50

(52) U.S. Cl. CPC G06T 7/73; G06F 16/5866; G06T 7/50

(57) ABSTRACT

This disclosure provides systems, devices, apparatus, and methods, including computer programs encoded on storage media, for sparse composition. A processor obtains at least one frame including at least one component, where the at least one component includes (1) data of the at least one component and (2) metadata of the at least one component, and where the metadata includes enclosing boundary information of the at least one component. The processor predicts, based on the enclosing boundary information and pose information, a set of boundary coordinates of the at least one component. The processor adjusts, based on a display order, the predicted set of boundary coordinates of the at least one component. The processor determines whether the predicted set of boundary coordinates overlaps with at least one component boundary associated with a composition engine. The processor processes, based on the determination, the data.

### CROSS REFERENCE TO RELATED APPLICATION(S)

This application claims the benefit of Indian Provisional Application No. 202341031043, entitled “SPARSE COMPOSITION” and filed on May 1, 2023, which is expressly incorporated by reference herein in its entirety. This application also claims the benefit of Indian Provisional Application No. 202321038422, entitled “DYNAMIC CONTENT-BASED MANAGEMENT OF SPARSE REPROJECTION” and filed on Jun. 5, 2023, which is expressly incorporated by reference herein in its entirety.

### TECHNICAL FIELD

The present disclosure relates generally to processing systems and, more particularly, to one or more techniques for display processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor.

Current techniques for augmented reality (AR) frame processing may process sparse frames and non-sparse frames in the same manner or a similar manner. There is a need for improved techniques pertaining to processing sparse frames.

Current techniques for reprojection and/or composition of extended reality (XR) content may not address different characteristics of hardware blocks used for reprojection and/or composition. There is a need for improved techniques pertaining to reprojection and/or composition of XR content.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus for display processing are provided. The apparatus includes a memory and a processor coupled to the memory and, based on information stored in the memory, the processor is configured to: obtain at least one frame including at least one component, where the at least one component includes (1) data of the at least one component and (2) metadata of the at least one component, and where the metadata includes enclosing boundary information of the at least one component; predict, based on the enclosing boundary information of the at least one component and pose information from a headset worn by a user corresponding to the at least one component, a set of boundary coordinates of the at least one component; adjust, based on a display order, an order of the predicted set of boundary coordinates of the at least one component; determine whether the predicted set of boundary coordinates overlaps with at least one component boundary associated with a composition engine; and process, based on the determination, the data of the at least one component.

In an aspect of the disclosure, a method, a computer-readable medium, and an apparatus for display processing are provided. The apparatus includes a memory; and a processor coupled to the memory and, based on information stored in the memory, the processor is configured to: calculate at least one of (1) a sparsity of rendered content or (2) a sparsity of a predicted composition associated with the rendered content; select, based on the calculation, an adaptive reprojection mode from amongst a plurality of adaptive reprojection modes; process the rendered content based on the selected adaptive reprojection mode; and output an indication of the processed rendered content.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example display framework including a display processor and a display in accordance with one or more techniques of this disclosure.

FIG. 4 is a diagram illustrating an example split augmented reality (AR) architecture in accordance with one or more techniques of this disclosure.

FIG. 5 is a diagram illustrating an example component of a frame in accordance with one or more techniques of this disclosure.

FIG. 6 is a diagram illustrating an example of component boundaries in accordance with one or more techniques of this disclosure.

FIG. 7 is a diagram illustrating an example of sparse frames in accordance with one or more techniques of this disclosure.

FIG. 8 is a diagram illustrating an example of sparse frame composition in accordance with one or more techniques of this disclosure.

FIG. 9 is a diagram illustrating an example of a processing pipeline for sparse frame composition in accordance with one or more techniques of this disclosure.

FIG. 10 is a diagram illustrating an example of a data flow into a composition engine in accordance with one or more techniques of this disclosure.

FIG. 11 is a diagram illustrating example aspects of composition in accordance with one or more techniques of this disclosure.

FIG. 12 is a diagram illustrating an example of a composition flow in accordance with one or more techniques of this disclosure.

FIG. 13 is a diagram illustrating an example of a composition flow in accordance with one or more techniques of this disclosure.

FIG. 14 is a communication flow diagram between a graphics processor/video decoder and a display in accordance with one or more techniques of this disclosure.

FIG. 15 is a flowchart of an example method of display processing in accordance with one or more techniques of this disclosure.

FIG. 16 is a flowchart of an example method of display processing in accordance with one or more techniques of this disclosure.

FIG. 17 is a diagram illustrating example aspects of augmented reality in accordance with one or more techniques of this disclosure.

FIG. 18 is a diagram illustrating aspects of managing adaptive reprojection in accordance with one or more techniques of this disclosure.

FIG. 19 is a communication flow diagram between a wearable display device (WDD) and a companion device in accordance with one or more techniques of this disclosure.

FIG. 20 is a flowchart of an example method of display processing in accordance with one or more techniques of this disclosure.

FIG. 21 is a flowchart of an example method of display processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

An augmented reality (AR) device may have a relatively high display resolution and/or a relatively high refresh rate, which may lead to increased memory use, bandwidth use, and/or power consumption for a reprojection pipeline associated with the AR device. In an example, the AR device may receive a rendered frame (i.e., a sparse frame) from a companion device (e.g., a mobile phone), where the rendered frame includes sparse content. A sparse frame may refer to a frame in which a limited portion (e.g., half of the frame, a quarter of the frame, an eight of the frame, etc.) of the frame includes content. The AR device may process the sparse frame in a manner similar to processing a dense frame (e.g., a frame in which a non-limited portion of the frame includes content); however, this may lead to redundant computation, inefficient use of memory, inefficient use of bandwidth, and/or increased power consumption.

Various technologies pertaining to sparse composition are described herein. In an example, an apparatus (e.g., a graphics processor) obtains at least one frame including at least one component, where the at least one component includes (1) data of the at least one component and (2) metadata of the at least one component, and where the metadata includes enclosing boundary information of the at least one component. The enclosing boundary information may refer to information about a two-dimensional or three-dimensional boundary that encloses the at least one component. In an example, the at least one frame may be a sparse frame that includes graphical content that occupies less than half of a display area. The apparatus predicts, based on the enclosing boundary information of the at least one component and pose information from a headset worn by a user corresponding to the at least one component, a set of boundary coordinates of the at least one component. The set of boundary coordinates may refer to two-dimensional or three-dimensional coordinates that enclose the at least one component. The apparatus adjusts, based on a display order, an order of the predicted set of boundary coordinates of the at least one component. The apparatus determines whether the predicted set of boundary coordinates overlaps with at least one component boundary associated with a composition engine. The at least one component boundary may be a boundary of a previous processed component. The apparatus processes, based on the determination, the data of the at least one component. Vis-à-vis the above-described technologies, the apparatus may process a frame (e.g., a sparse frame) in a manner that may lead to reduced computation, more efficient use of memory, more efficient use of bandwidth, and/or reduced power consumption.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

Extended reality (XR) content may be sparse when presented on a display panel, that is, the XR content may occupy less than a certain percentage (e.g., 50%) of a display panel when presented on the display panel. Some wearable display devices used for XR may have hardware blocks that are optimized for sparse content and not optimized for non-sparse content, that is, a wearable display device may include a hardware block for reprojection that offers reduced power consumption for sparse content, but the hardware block may utilize increased power consumption for reprojection of full-screen content.

Various technologies pertaining to dynamic content-based management of sparse reprojection are disclosed herein. In an example, an apparatus (e.g., a wearable display device), calculates at least one of (1) a sparsity of rendered content (e.g., XR content) or (2) a sparsity of a predicted composition associated with the rendered content. The apparatus selects, based on the calculation, an adaptive reprojection mode from amongst a plurality of adaptive reprojection modes. The apparatus processes the rendered content based on the selected adaptive reprojection mode. The apparatus outputs an indication of the processed rendered content. Vis-à-vis selecting the adaptive reprojection mode based on the sparsity of the rendered content and/or the sparsity of the predicted composition, the apparatus (e.g., a wearable display device) may process rendered content in a manner that is suited for sparse content. For instance, if the rendered content is sparse, a wearable display device may utilize an adaptive reprojection mode suited for sparse content, and if the rendered content is non-sparse, the wearable display device may utilize an adaptive reprojection mode suited for non-sparse content. This may result in reduced power consumption at the wearable display device, as the wearable display device may avoid utilizing an adaptive reprojection mode optimized for sparse content when the rendered content is non-sparse or vice-versa.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

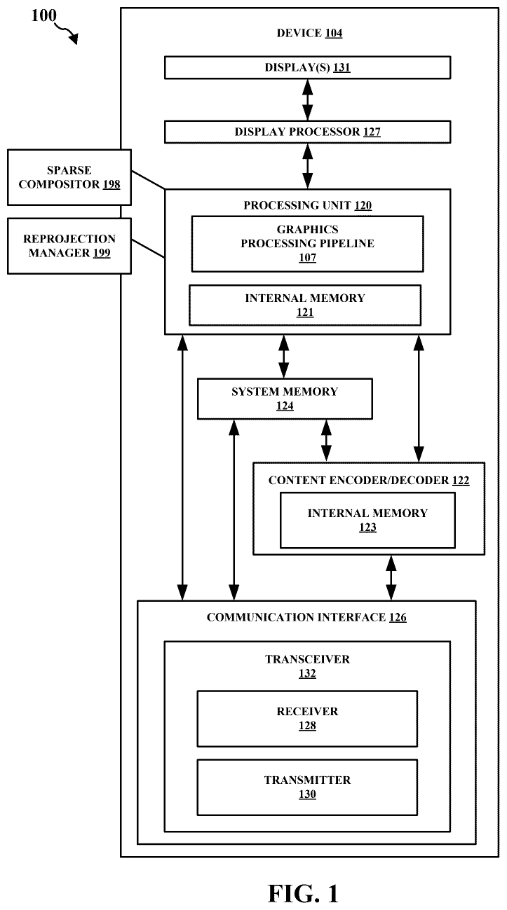

FIG. 1 is a block diagram that illustrates an example content generation system 100 configured to implement one or more techniques of this disclosure. The content generation system 100 includes a device 104. The device 104 may include one or more circuits for performing various functions described herein. The device 104 may include hardware and/or software configured to perform one or more techniques of this disclosure. In the example shown, the device 104 may include a processing unit 120, a content encoder/decoder 122, and a system memory 124. In some aspects, the device 104 may include a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content. The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the display processor 127 and/or the processing unit 120 may include a sparse compositor 198 configured to obtain at least one frame including at least one component, where the at least one component includes (1) data of the at least one component and (2) metadata of the at least one component, and where the metadata includes enclosing boundary information of the at least one component; predict, based on the enclosing boundary information of the at least one component and pose information from a headset worn by a user corresponding to the at least one component, a set of boundary coordinates of the at least one component; adjust, based on a display order, an order of the predicted set of boundary coordinates of the at least one component; determine whether the predicted set of boundary coordinates overlaps with at least one component boundary associated with a composition engine; and process, based on the determination, the data of the at least one component. Although the following description may be focused on display processing, the concepts described herein may be applicable to other similar processing techniques. Furthermore, although the following description may focus on AR, these concepts described herein may also be applied to other types of extended reality (XR) technologies, such as virtual reality (VR) and mixed reality (MR). Additionally, although the following description may focus on wearable display devices for XR (including AR, MR, and VR), the concepts presented herein may also be applicable to XR for non-wearable display devices (e.g., XR content presented on a windshield of a vehicle).

In certain aspects, the display processor 127 and/or the processing unit 120 may include a reprojection manager 199 configured to calculate at least one of (1) a sparsity of rendered content or (2) a sparsity of a predicted composition associated with the rendered content; select, based on the calculation, an adaptive reprojection mode from amongst a plurality of adaptive reprojection modes; process the rendered content based on the selected adaptive reprojection mode; and output an indication of the processed rendered content. Although the following description may be focused on display processing, the concepts described herein may be applicable to other similar processing techniques. Furthermore, although the following description may be focused on XR in a wearable display device context, the concepts described herein may also be applicable to XR in a non-wearable display device context.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by particular hardware (e.g., a GPU), but, in further embodiments, may be performed using other hardware and/or software, consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

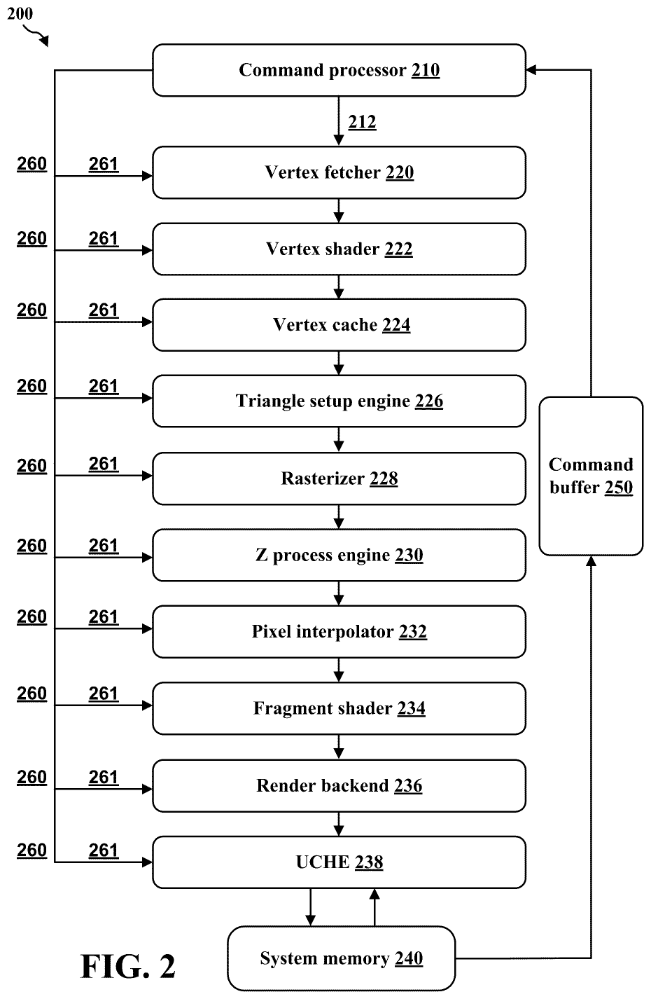

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUS according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

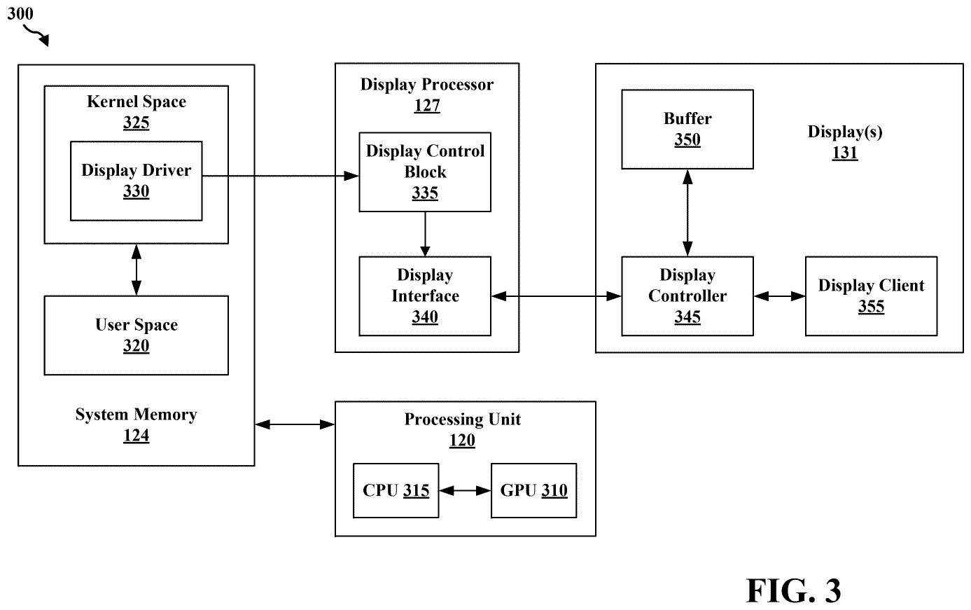

FIG. 3 is a block diagram 300 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 310 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 310 may be controlled based on one or more graphics processing commands provided by a CPU 315. The CPU 315 may be configured to execute multiple applications concurrently. In some cases, each of the concurrently executed multiple applications may utilize the GPU 310 simultaneously. Processing techniques may be performed via the processing unit 120 output a frame over physical or wireless communication channels.

The system memory 124, which may be executed by the processing unit 120, may include a user space 320 and a kernel space 325. The user space 320 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 325 may further include a display driver 330. The display driver 330 may be configured to control the display processor 127. For example, the display driver 330 may cause the display processor 127 to compose a frame and transmit the data for the frame to a display.

The display processor 127 includes a display control block 335 and a display interface 340. The display processor 127 may be configured to manipulate functions of the display(s) 131 (e.g., based on an input received from the display driver 330). The display control block 335 may be further configured to output image frames to the display(s) 131 via the display interface 340. In some examples, the display control block 335 may additionally or alternatively perform post-processing of image data provided based on execution of the system memory 124 by the processing unit 120.

The display interface 340 may be configured to cause the display(s) 131 to display image frames. The display interface 340 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 350.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 350. For example, when a Vsync pulse is generated, the display processor 127 may output new graphical content to the buffer 350. Thus, generation of the Vsync pulse may indicate that current graphical content has been rendered at the buffer 350.

Frames are displayed at the display(s) 131 based on a display controller 345, a display client 355, and the buffer 350. The display controller 345 may receive image data from the display interface 340 and store the received image data in the buffer 350. In some examples, the display controller 345 may output the image data stored in the buffer 350 to the display client 355. Thus, the buffer 350 may represent a local memory to the display(s) 131. In some examples, the display controller 345 may output the image data received from the display interface 340 directly to the display client 355.

The display client 355 may be associated with a touch panel that senses interactions between a user and the display(s) 131. As the user interacts with the display(s) 131, one or more sensors in the touch panel may output signals to the display controller 345 that indicate which of the one or more sensors have sensor activity, a duration of the sensor activity, an applied pressure to the one or more sensor, etc. The display controller 345 may use the sensor outputs to determine a manner in which the user has interacted with the display(s) 131. The display(s) 131 may be further associated with/include other devices, such as a camera, a microphone, and/or a speaker, that operate in connection with the display client 355.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 310 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining cach of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

A user may wear a display device in order to experienced extended reality (XR) content. XR may refer to a technology that blends aspects of a digital experience and the real world. XR may include augmented reality (AR), mixed reality (MR), and/or virtual reality (VR). In AR, AR objects may be superimposed on a real-world environment as perceived through the display device. In an example, AR content may be experienced through AR glasses that include a transparent or semi-transparent surface. An AR object may be projected onto the transparent or semi-transparent surface of the glasses as a user views an environment through the glasses. In general, the AR object may not be present in the real world and the user may not interact with the AR object. In MR, MR objects may be superimposed on a real-world environment as perceived through the display device and the user may interact with the MR objects. In some aspects, MR objects may include “video see through” with virtual content added. In an example, the user may “touch” a MR object being displayed to the user (i.e., the user may place a hand at a location in the real world where the MR object appears to be located from the perspective of the user), and the MR object may “move” based on the MR object being touched (i.e., a location of the MR object on a display may change). In general, MR content may be experienced through MR glasses (similar to AR glasses) worn by the user or through a head mounted display (HMD) worn by the user. The HMD may include a camera and one or more display panels. The HMD may capture an image of environment as perceived through the camera and display the image of the environment to the user with MR objects overlaid thereon. Unlike the transparent or semi-transparent surface of the AR/MR glasses, the one or more display panels of the HMD may not be transparent or semi-transparent. In VR, a user may experience a fully-immersive digital environment in which the real-world is blocked out. VR content may be experienced through a HMD.

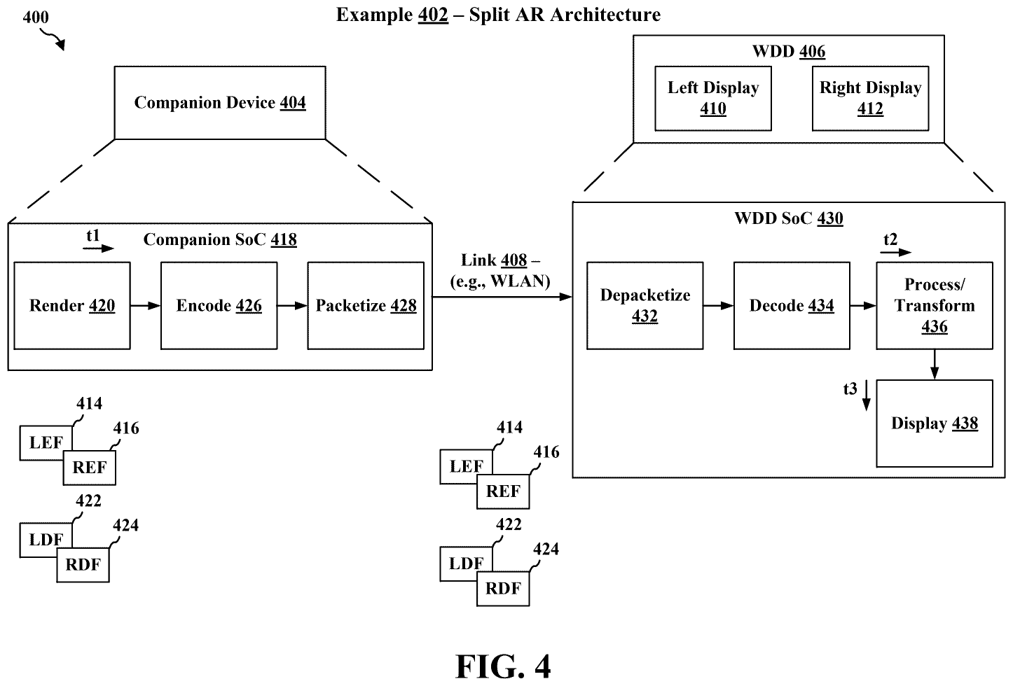

FIG. 4 is a diagram 400 illustrating an example of a split AR architecture 402 (i.e., a split AR system) in accordance with one or more techniques of this disclosure. The split AR architecture 402 may include a companion device 404 and a wearable display device (WDD) 406. In general, the companion device 404 and the WDD 406 may communicate over a link 408 in order to facilitate the display of AR content (i.e., AR frames) on the WDD 406. The companion device 404 may have a greater amount of computational processing power in comparison to computational processing power of the WDD 406. As such, rendering workloads (and other workloads) may be offloaded to the companion device 404 in order to preserve computational resources and/or battery life at the WDD 406. The link 408 may be a wired link (e.g., a universal serial bus (USB)) link or a wireless link (e.g., a wireless local area network (WLAN) link, a Bluetooth® link, a cellular link, such as a 5G New Radio (5G NR) link, etc.).

The companion device 404 may alternatively be referred to as a host, a host device, a companion, or a remote device. In an example, the companion device 404 may be or include desktop computing device(s), laptop computing device(s), tablet(s), smartphone(s), gaming console(s), and/or server(s), such as cloud server(s). Although not depicted in FIG. 4, the companion device 404 may include hardware such as processor(s), memory, data storage, input/output hardware, etc. In an example, the companion device may be the device 104.

The WDD 406 may alternatively be referred to as a headset, AR glasses, or a HMD. The WDD 406 may be worn on/over/around a head of a user such that a left display 410 and a right display 412 are positioned several centimeters from a left eye of the user and a right eye of the user, respectively. As described in greater detail below, the WDD 406 may (1) receive first rendered content and second rendered content from the companion device 404, (2) process the first rendered content and the second rendered content, and (3) present the first processed rendered content and the second rendered content on the left display 410 and the right display 412 concurrently (or substantially concurrently), respectively. In an example, when viewed by the user, the first processed rendered content and the second processed rendered content may be perceived to be a virtual object present in an environment of the user. Although not depicted in FIG. 4, the WDD 406 may include hardware such as processor(s), memory, data storage, input/output hardware, etc. In an example, the WDD 406 may be the device 104.

The companion device 404 may include a companion system system-on-chip (SoC) 418. At time t1, the companion SoC 418 may render 420 AR content for the WDD 406. The (rendered) AR content may include a left eye frame (LEF) 414 for the left eye of the user and a right eye frame (REF) 416 for the right eye of the user. The AR content may also include a left depth frame (LDF) 422 corresponding to the LEF 414 and a right depth frame (RDF) 424 corresponding to the REF 416. The companion SoC 418 may render 420 the AR content based on data from the WDD SoC, input at the companion device 404, and/or data from other sources. The companion SoC 418 may encode 426 the rendered AR content. The companion SoC 418 may packetize 428 the encoded rendered AR content. The companion SoC 418 may transmit the packetized, encoded rendered AR content over the link 408 to the WDD 406.

The WDD 406 may include a WDD SoC 430. The WDD SoC 430 may depacketize 432 the packetized, encoded rendered AR content transmitted by the companion SoC 418 to obtain encoded rendered AR content. The WDD SoC 430 may decode 434 the encoded rendered AR content to obtain rendered AR content. At time t2, the WDD SoC 430 may process/transform 436 (e.g., perform a late stage reprojection (LSR), explained in greater detail below) the rendered AR content. At time t3, the WDD SoC 430 may display 438 the processed/transformed rendered AR content on the left display 410 and the right display 412.

As discussed above, the companion SoC 418 may render the LEF 414, the REF 416, the LDF 422, and the RDF 424 at time tl. In an example, the companion SoC 418 may render the LEF 414, the REF 416, the LDF 422, and the RDF 424 based on pose information and/or motion information of the WDD 406 that is available to the companion SoC 418 at time t1. The pose information may include a six degree-of-freedom (6DOF) pose. The 6DOF pose may include a location (e.g., an x-coordinate, a y-coordinate, and a z-coordinate) of the WDD 406 and an orientation (e.g., a roll, a pitch, and a yaw) of the WDD 406. The motion information may include a speed to the WDD 406. The WDD 406 may receive the LEF 414, the REF 416, the LDF 422, and the RDF 424, decode the LEF 414, the REF 416, the LDF 422, and the RDF 424 at time t2, process the LEF 414, the REF 416, the LDF 422, and the RDF 424, and send the LEF 414, the REF 416, the LDF 422, and the RDF 424 for display at time t3.

A user wearing the WDD 406 may move between time t1 and time t2 and/or an orientation of a head of the user wearing the WDD 406 may change between time t1 and time2. As a result of movement between time t1 and time t2 and/or a change in the orientation of the head of the user between time t1 and time t2, rendered objects may be displayed in places in a scene that are not expected by the user. To account for movement and/or orientation changes of the user and to minimize visual discrepancies, at time t2, the WDD SoC 430 may warp eye buffers corresponding to the AR content based on latest available pose information of the WDD 406. Warping the eye buffers based on the latest available pose information may be referred to as LSR or asynchronous reprojection.

In AR devices, high display resolutions and/or refresh rates may lead to increased memory consumption and/or bandwidth characteristics for a reprojection pipeline (e.g., a LSR pipeline). Thus, high display resolutions and/or high refresh rates may lead to an increase in power consumption at AR devices. Frames rendered on a companion device may often include sparse content. Such frames may be referred to as sparse frames. A sparse frame may refer to a frame in which a limited portion (e.g., half of the frame, a quarter of the frame, an eighth of the frame, etc.) of the frame includes content. An encoding process at a companion device and a decoding process at a WDD may handle sparse content during transmission by compression/decompression techniques. A decoding reprojection pipeline at a WDD may benefit from taking advantage of sparseness in a frame. Processing a sparse frame in the same or a similar manner as a dense frame (e.g., a frame in which a large portion (e.g., greater than half of the frame, greater than 75% of the frame, etc.) of the frame includes graphical content) may lead to redundant computation, increased memory use, increased bandwidth consumption, and/or increased power consumption at the WDD. Content and corresponding metadata may be rendered on a WDD (i.e., a local device) using a GPU or the content and the corresponding metadata may be received from a companion device (i.e., a remote device) through a communication interface, where the content and the corresponding metadata may be decoded on the WDD using a video decoder. Portions of content in sparse frames (e.g., enclosing boundaries) may be indicated through metadata. The term “metadata” may refer to data that describes and/or provides information about other data. The information about the other data may or may not relate to the content of the data itself. Some examples of metadata may be information regarding textures, attributes, and uniforms. Example metadata may also include boundary information, a depth indication, a depth boundary, an indication of alpha information, a component type, and/or composition criteria.

Aspects presented herein may utilize metadata (i.e., sparse patch metadata) in composition. Composition may refer to combining a plurality of rendered layers into a frame. In one aspect, the method of organizing output of a warping stage is described herein. In another aspect, a method of handling overlays and blending is described herein. In yet another aspect, a method of composing different patches/components into a single composite display buffer is described herein. In some aspects, for split XR, aspects presented herein may use metadata to indicate regions/layers of sparse content. Aspects presented herein may also perform reprojection/warping separately, using sparse content optimized warping for sparse regions/layers. Aspects presented herein may also utilize composition engine monitor warping (e.g., using tables) to determine when warping is complete and a final composition may occur.

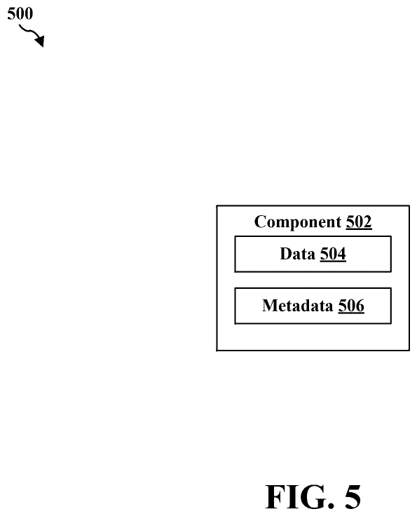

FIG. 5 is a diagram 500 illustrating an example component 502 of a frame in accordance with one or more techniques of this disclosure. The component 502 of the frame may be generated by a companion device and transmitted to a WDD. The component 502 may include data 504 and metadata 506. The component 502 may also be referred to as a patch. As mentioned herein, example components of a frame may include data or metadata. Further, one example of a component of a frame (e.g., component 502) may be a sparse frame, which may refer to a type of frame wherein a portion of the frame (e.g., half of the frame, a quarter of the frame, an eighth of the frame, etc.) includes content. Another example of a component of a frame (e.g., component 502) may be a patch, which may refer to a portion of a frame (i.e., the frame is partitioned into different patches).

The data 504 may include color information, gray scale information, depth information, and/or an alpha level. Color information may refer to color values of pixels associated with the frame. Gray scale information may refer to gray scale values of pixels associated with the frame. Depth information may refer to information used to display the frame at a proper depth on a AR display. An alpha level may refer to a transparency of the frame.

The metadata 506 may include enclosing boundary information, a depth indication, a depth boundary, an indication of alpha information, a component type, and/or composition criteria. The enclosing boundary information may refer to a two-dimensional boundary (e.g., in an xy plane) around graphical content (e.g., an object) associated with the component 502. The depth indication may be similar or identical to the depth information of the data 504. The depth boundary may refer to a boundary of the object associated with the component with respect to a z axis. The alpha information may be similar or identical to the alpha level of the data 504. The component type may refer to a shape associated with the enclosing boundary information (e.g., rectangle, triangle, square, etc.). The composition criteria may refer to instructions for composing the component with different layers.

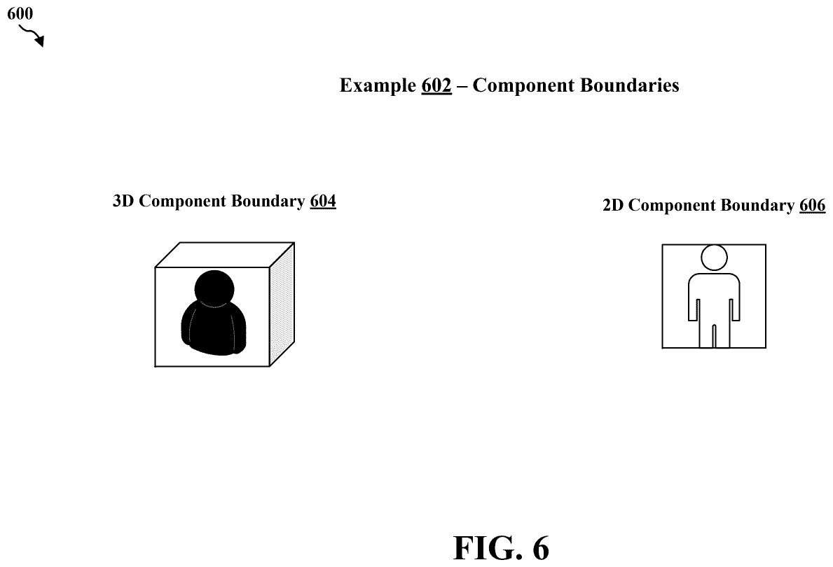

FIG. 6 is a diagram 600 illustrating an example 602 of component boundaries in accordance with one or more techniques of this disclosure. A device (e.g., a companion device, a WDD, etc.) may compute boundaries around components that are to be displayed. In an example, a boundary around a component may enclose the component. The boundary may be a shape (i.e., a polygon). The boundary may be a rectangle, a square, a cube, or a rectangular prism. The computed boundaries may be used for composition purposes. For example, a device may check boundaries of components (as opposed to the dimensions of the components themselves, which may be irregular and difficult to check) to determine whether the components overlap. The device may then determine how to compose the components based on the check. The diagram 600 depicts a 3D component boundary 604 and a 2D component boundary 606.

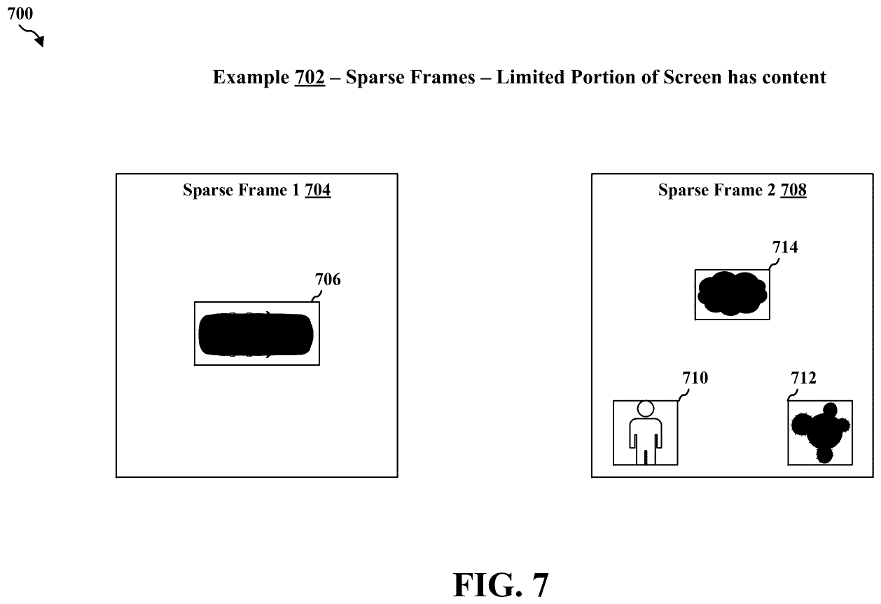

FIG. 7 is a diagram 700 illustrating an example 702 of sparse frames in accordance with one or more techniques of this disclosure. As discussed above, a sparse frame may be a frame that, when displayed on a display (i.e., a screen), includes graphical content that occupies a limited portion of the display. In an example, the limited portion may be less than 50% (e.g., 40%, 20%, 10%, 5%, etc.).

The diagram 700 depicts a first sparse frame 704 that includes graphical content 706 corresponding to a component (e.g., the component 502). The diagram 700 also depicts a second sparse frame 708 that includes first graphical content 710 corresponding to a first component, second graphical content 712 corresponding to a second component, and third graphical content 714 corresponding to a third component.

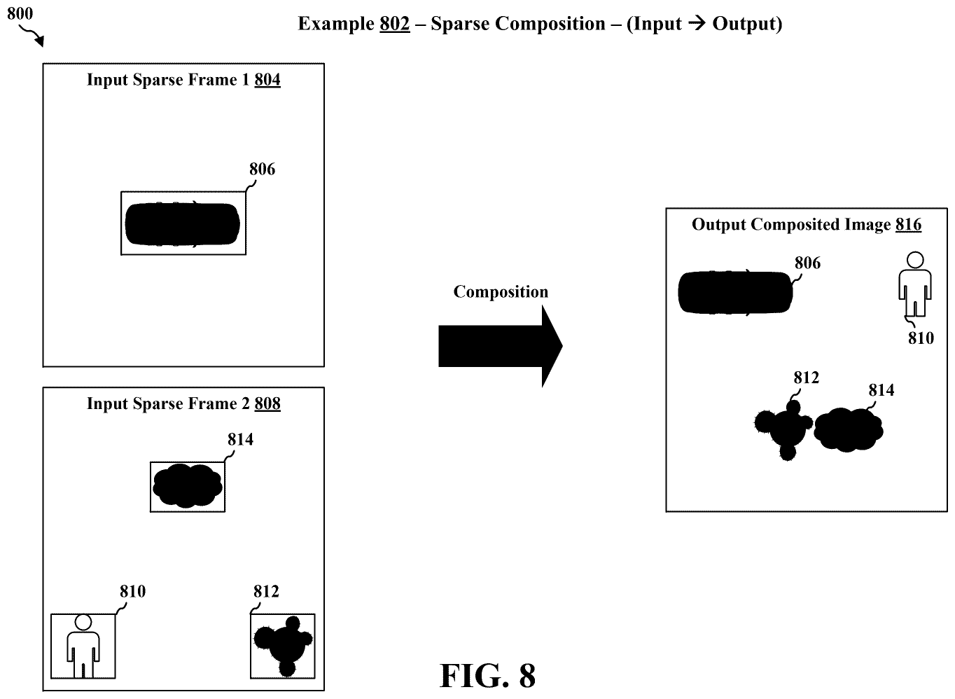

FIG. 8 is a diagram 800 illustrating an example 802 of sparse frame composition in accordance with one or more techniques of this disclosure. Sparse frame composition may refer to compositing at least two sparse frames to produce a composited image. In an example, a device (e.g., a companion device, a WDD) may perform a composition on a first input sparse frame 804 including graphical content 806 corresponding to a component and a second input sparse frame 808 including first graphical content 810 corresponding to a first component, second graphical content 812 corresponding to a second component, and third graphical content 814 corresponding to a third component to produce an output composited image 816, where the output composited image 816 includes the graphical content 806 corresponding to the component, the first graphical content 810 corresponding to the first component, the second graphical content 812 corresponding to the second component, and third graphical content 814 corresponding to the third component.

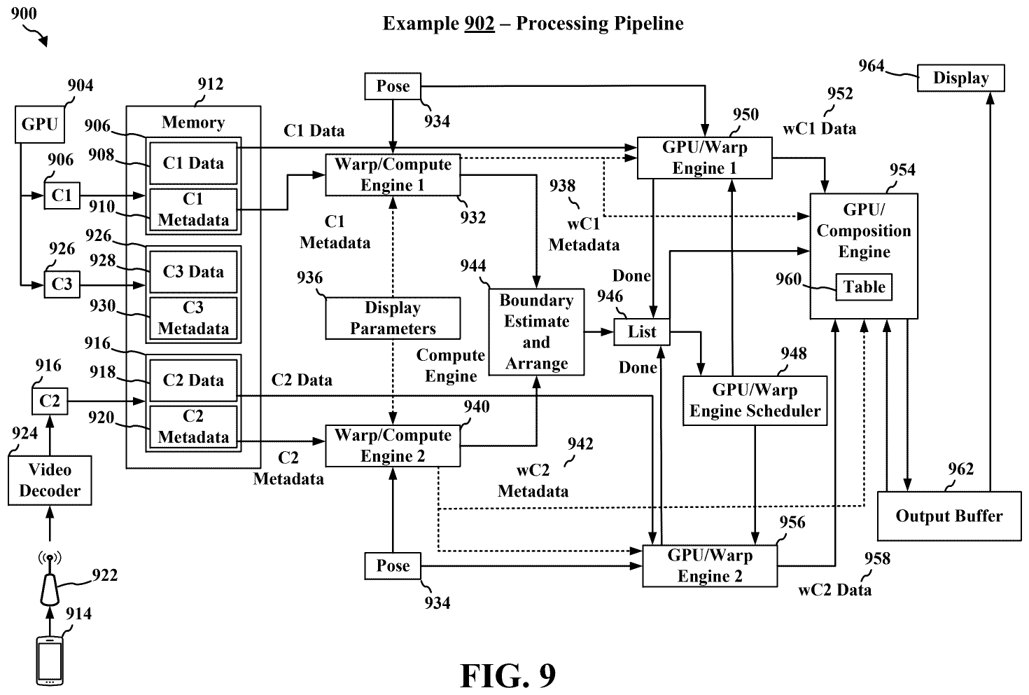

FIG. 9 is a diagram 900 illustrating an example 902 of a processing pipeline for sparse frame composition in accordance with one or more techniques of this disclosure. The processing pipeline may be implemented in hardware and/or of software of a WDD, such as the WDD 406. As described in greater detail below, the processing pipeline may organize output of a warping stage, handle overlays and blending of components, and/or compose different patches/components into a single composite display buffer.

A WDD implementing the processing pipeline may obtain frame(s), where the frame(s) may include component(s) (e.g., the component 502). In an example, a GPU 904 at the WDD may render a first component 906 (referred to in FIG. 9 as “C1”), where the first component 906 includes first data 908 (referred to in FIG. 9 at “C1 Data”) and first metadata 910 (referred to in FIG. 9 as “C1 Metadata”). The first component 906 may be or include the component 502. In an example, the first component 906 may correspond to a sparse frame (e.g., the first sparse frame 704). The WDD may store the first component 906 in memory 912. In an example, a companion device 914 may render a second component 916 (referred to in FIG. 9 as “C2”), where the second component 916 includes second data 918 (referred to in FIG. 9 as “C2 Data”) and second metadata 920 (referred to in FIG. 9 as “C2 Metadata”). The companion device 914 may transmit the second component 916 (e.g., a frame including the second component 916) over a wireless connection 922. A video decoder 924 of the WDD may obtain the second component 916. The video decoder 924 may decode the second component 916 if the second component is encoded. In an example, the second component 916 may correspond to a sparse frame (e.g., the second sparse frame 708). The WDD may store the second component 916 in the memory 912. In an example, the GPU 904 at the WDD may render a third component 926 (referred to in FIG. 9 as “C3”), where the third component 926 includes third data 928 (referred to in FIG. 9 at “C3 Data”) and third metadata 930 (referred to in FIG. 9 as “C3 Metadata”). The WDD may store the third component 926 in the memory 912. In an example, the third component 926 may correspond to a sparse frame.

For ease of explanation, the description of the processing pipeline in FIG. 9 set forth below focuses on the first component 906 and the second component 916; however, the concepts described herein with respect to the processing pipeline may be applicable to more than two components (e.g., the concepts described herein may also be applicable to the third component 926).

A first warp/compute engine 932 may obtain/access the first metadata 910. The first warp/compute engine 932 may obtain a pose 934 (e.g., a 6DOF pose) of the WDD. The first warp/compute engine 932 may warp the first metadata 910 based on the pose 934, that is, the first warp/compute engine 932 may change values of the first metadata 910 to account for movement of the WDD as reflected by the pose 934. In one aspect, the first warp/compute engine 932 may also obtain display parameters 936 for display(s) of the WDD. In an example, the display parameters 936 may include a size of the display(s). The first warp/compute engine 932 may warp the first metadata 910 based on the display parameters 936 and the pose 934. Warping the first metadata 910 may generate first warped metadata 938 (referred to in FIG. 9 as “wC1 Metadata”).

A second warp/compute engine 940 may obtain/access the second metadata 920. The second warp/compute engine 940 may obtain the pose 934 of the WDD. The second warp/compute engine 940 may warp the second metadata 920 based on the pose 934, that is, the second warp/compute engine 940 may change values of the second metadata 920 to account for movement of the WDD as reflected by the pose 934. In one aspect, the second warp/compute engine 940 may also obtain the display parameters 936. The second warp/compute engine 940 may warp the second metadata 920 based on the display parameters 936 and the pose 934. Warping the second metadata 920 may generate second warped metadata 942 (referred to in FIG. 9 as “wC2 Metadata”). Warping the first metadata 910 and the second metadata 920 may occur at the same time instance or at different time instances. For instance, warping of the first metadata 910 and the second metadata 920 may begin at a first time instance; however, the warping of the first metadata 910 may finish at a second time instance and the warping of the second metadata 920 may finish at a third time instance, where the first time instance, the second time instance, and the third time instance may be different.

At 944, the WDD (via a compute engine) may estimate boundaries of the first component 906 and the second component 916 based on the first warped metadata 938 and the second warped metadata 942. The WDD may then arrange an indication of the first component 906 and an indication of the second component 916. For instance, the WDD may arrange the indication of the first component 906 and the indication of the second component 916 in a list 946 based on a display order. In an example, the WDD may arrange the list 946 by first sorting the list 946 according to a vertical order (y-axis) and then sorting the list 946 according to a horizontal order (x-axis). The list 946 may include respective indications as to whether metadata warping is complete with respect to different components in order to facilitate asynchronous warping of data corresponding to the metadata. In an example, the list 946 may indicate that warping of the first metadata 910 is complete and that warping of the second metadata 920 is not yet complete. When warping of the second metadata 920 is complete, the list 946 may be updated to indicate that the warping of the second metadata 920 is complete. A GPU/warp engine scheduler 948 may obtain the indication of the (arranged) first component 906 and the indication of the (arranged) second component 916. For instance, the GPU/warp engine scheduler 948 may obtain the list 946. The GPU/warp engine scheduler 948 may schedule warping of the first data 908 and the second data 918 based on the indication of the (arranged) first component 906 and the indication of the (arranged) second component 916

A first GPU/warp engine 950 may obtain the first data 908 of the first component 906. The first GPU/warp engine 950 may also obtain the pose 934. The first GPU/warp engine 950 may obtain scheduling information for the first component 906 from the GPU/warp engine scheduler 948. The first GPU/warp engine 950 may warp the first data 908 based on the pose 934 and the scheduling information for the first component 906, that is, the first GPU/warp engine 950 may change values of the first data 908 to account for movement of the WDD as reflected by the pose 934. In one aspect, the first GPU/warp engine 950 may obtain the first warped metadata 938 and the first GPU/warp engine 950 may additionally warp the first data 908 based on the first warped metadata 938. Warping the first data 908 may generate first warped data 952 (referred to in FIG. 9 as “wC1 Data”). The first GPU/warp engine 950 may provide an indication that warping of the first data 908 has been completed (referred to in FIG. 9 as “Done”) to logic associated with maintaining the list 946. The list 946 may be updated based on the indication. The first GPU/warp engine 950 may provide the first warped data 952 (or an indication thereof) to a GPU/composition engine 954. The term “composition engine” may refer to a component that is associated with a composition process (i.e., the process of putting together elements from different sources to create or compose a display image) at a graphics processor or GPU. The composition engine may obtain a table or a list that is associated with data for a composition process. The composition engine may maintain or process data that is associated with the composition process. The composition engine may also update or warp data that is associated with a composition process. A composition engine may be included in a graphics processor or GPU, may be part of a graphics processor or GPU, or may be a graphics processor or GPU.

A second GPU/warp engine 956 may obtain the second data 918 of the second component 916. The second GPU/warp engine 956 may also obtain the pose 934. The second GPU/warp engine 956 may obtain scheduling information for the second component 916 from the GPU/warp engine scheduler 948. The second GPU/warp engine 956 may warp the second data 918 based on the pose 934 and the scheduling information for the second component 916, that is, the second GPU/warp engine 956 may change values of the second data 918 to account for movement of the WDD as reflected by the pose 934. In one aspect, the second GPU/warp engine 956 may obtain the second warped metadata 942 and the second GPU/warp engine 956 may additionally warp the second data 918 based on the second warped metadata 942. Warping the second data 918 may generate second warped data 958 (referred to in FIG. 9 as “wC2 Data”). The second GPU/warp engine 956 may provide an indication that warping of the second data 918 has been completed (referred to in FIG. 9 as “Done”) to logic associated with maintaining the list 946. The list 946 may be updated based on the indication. The second GPU/warp engine 956 may provide the second warped data 958 (or an indication thereof) to the GPU/composition engine 954.

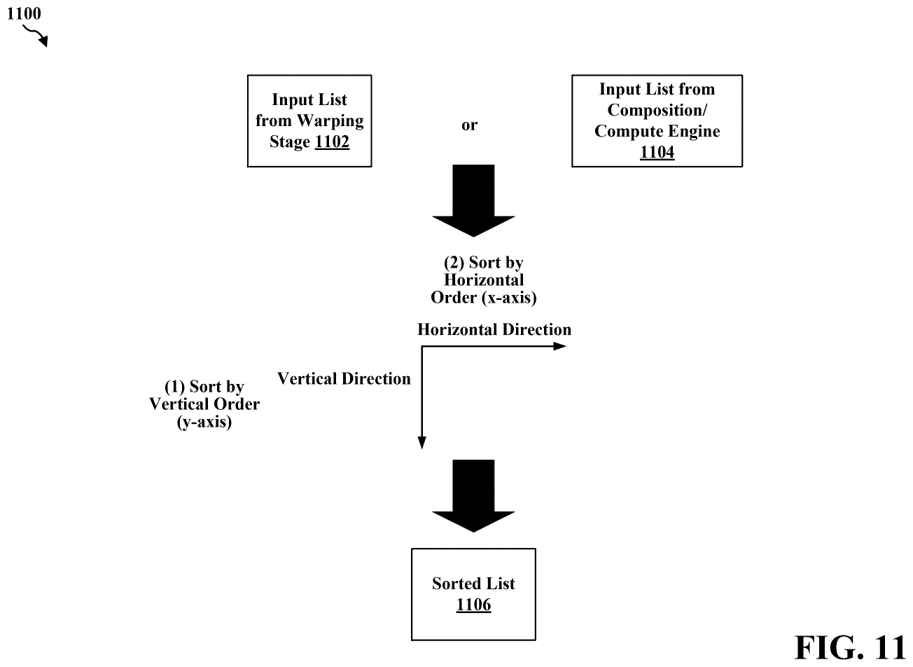

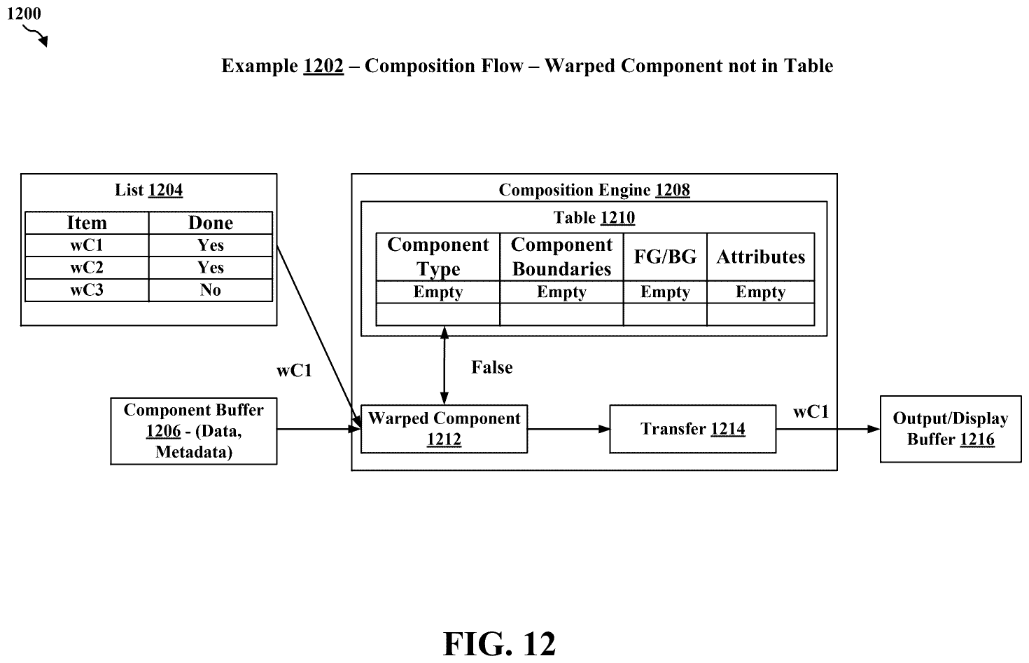

The GPU/composition engine 954 may maintain a table 960, where the table 960 includes entries for components that have been processed by the GPU/composition engine 954. The GPU/composition engine 954 may process the first warped data 952 and the second warped data 958 based on the table 960 and the list 946. The processing performed by the GPU/composition engine 954 and the table 960 is discussed in greater detail below in the description of FIG. 11 and FIG. 12. In one aspect, the GPU/composition engine 954 may obtain the first warped metadata 938 and the second warped metadata 942. In such an aspect, the GPU/composition engine 954 may process the first warped data 952 and the second warped data 958 additionally based on the first warped metadata 938 and the second warped metadata 942. Subsequent to processing, the first warped data 952 and the second warped data 958 may be transferred to an output buffer 962. At 964, graphical content corresponding to the first warped data 952 and the second warped data 958 may be presented on display(s) of the WDD.

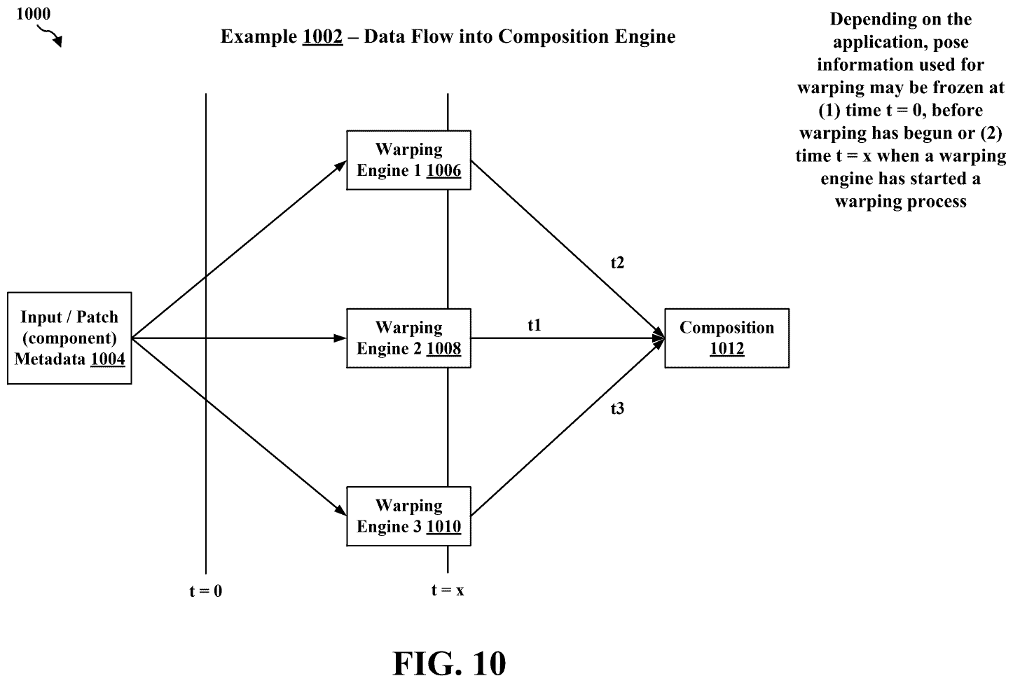

FIG. 10 is a diagram 1000 illustrating an example 1002 of a data flow into a composition engine in accordance with one or more techniques of this disclosure. Input/patch metadata 1004 (e.g., the first metadata 910, the second metadata 920, the third metadata 930) corresponding to different components (e.g., the first component 906, the second component 916, the third component 926) may be provided to different warp engines. In an example, a first warping engine 1006 may obtain first metadata for a first component, a second warping engine 1008 may obtain second metadata for a second component, and a third warping engine 1010 may obtain third metadata for a third component. In an example, the first warping engine 1006 may be the first GPU/warp engine 950 and the second warping engine 1008 may be the second GPU/warp engine 956. The first warping engine 1006, the second warping engine 1008, and the third warping engine 1010 may respectively warp the first metadata, the second metadata, and the third metadata based on a pose (e.g., the pose 934) of a WDD. In an example, the second warping engine 1008 may complete the warping of the second metadata at time t1, the first warping engine 1006 may complete the warping of the first metadata at time t2, and the third warping engine 1010 may complete the warping of the third metadata at time t3, where time t1, time t2, and time t3 may be different. A WDD may perform a composition 1012 based on the warped first metadata, the warped second metadata, and the third warped metadata. In an example, the GPU/composition engine 954 may perform the composition 1012.

Depending on an application being executed by a WDD/companion device, the pose (i.e., pose information) used for warping may be selected (i.e., “frozen”) at different times. In one aspect, the pose used for warping may be selected at time t=0, that is, the WDD may select the pose at a time prior to the beginning of warping of the first metadata, the second metadata, and the third metadata. In another aspect, the pose used for warping may be selected at time t=x, that is, the pose may be selected at a time when a warping engine has started a warping process (i.e., a time at which a warping engine begins to warp metadata). In an example, t=x may correspond to a time at which the second warping engine 1008 starts a warping process.

FIG. 11 is a diagram 1100 illustrating example aspects of composition in accordance with one or more techniques of this disclosure. As discussed above, a composition engine (e.g., the GPU/composition engine 954) may obtain an input list (e.g., the list 946), where the input list may include indications of components. The input list may also include indications as to whether warping has been completed for the components. In one aspect, a composition/compute engine (e.g., the GPU/composition engine 954) may obtain an input list from a warping stage 1102. In another aspect, the composition/compute engine may compute output component boundaries and hence the input list may be an input list from composition/compute engine 1104. In such an aspect, the composition/compute engine may compute output component boundaries based on a pose determined at a particular time (e.g., t=0, t=x, etc. as described above in the description of FIG. 10). The composition/compute engine may ensure that component boundaries are within display grid boundaries. In an example, a composition/compute engine may reproject metadata (e.g., component boundary points, depth boundaries if available) for a component using a pose in order to determine output enclosing boundaries. A depth boundary may be used in subsequent processing for foreground/background determination.

The WDD may sort the list (e.g., the input list from warping stage 1102 or the input list from composition/compute engine 1104) based on a display order. For instance, the WDD may first sort the list by a vertical order (y-axis) and then sort the list by a horizontal order (x-axis) in order to generate a sorted list 1106. The sorted list 1106 may correspond to the list 946.

FIG. 12 is a diagram 1200 illustrating an example 1202 of a composition flow in accordance with one or more techniques of this disclosure. The WDD may maintain a list 1204, where the list 1204 may include identifiers for warped components (e.g., wC1, wC2, wC3) as well as indications as to whether a warping process has been completed for each of the warped components. In an example, the list 1204 may indicate that warping of a first component and a second component has been completed, but that warping of a first component has not yet been completed. The list 1204 may be the list 946. The list 1204 may be sorted as described above in connection with FIG. 11.

A component buffer 1206 may store (warped) data (e.g., color data) and (warped) metadata of a component (e.g., the component 502). In one example, the component buffer 1206 may store all or some of the warped data and the component buffer 1206 may some all or some of the warped metadata.

A composition engine 1208 (e.g., the GPU/composition engine 954) may maintain a table 1210 (e.g., the table 960). The table 1210 may also be referred to as an internal table. The table 1210 may store information for components that have been processed by the composition engine 1208. In an example, for each component in the table 1210, the table 1210 may store an indication of a type of a component, component boundaries of the component, an indication as to whether the component is to be displayed in a foreground (FG) or a background (BG) of a frame, and attributes (e.g., an alpha level) of the component.

The composition engine 1208 may read the list 1204 on a per component basis. In an example, the composition engine 1208 may read wC1 from the list, where wC1 corresponds to a warped component 1212. The composition engine 1208 may check if the warped component 1212 has completed a warping stage. If the warped component 1212 has completed the warping stage, the warped component 1212 may be ready to be processed. The composition engine 1208 may perform a coordinate check against the table 1210 based on the warped component 1212. If the coordinate check returns no results (i.e., if predicted boundary coordinates of the warped component 1212 are outside of a component boundary included in the table 1210), the composition engine 1208 may transfer 1214 the data from the component buffer 1206 into an output/display buffer 1216. In one aspect, the composition engine 1208 may perform an additional coordinate check within component boundaries of the warped component 1212 prior to transferring the warped component. After the data has been transferred to the output/display buffer 1216, the composition engine 1208 may update the table 1210. In the example depicted in the diagram 1200, the table 1210 is empty, and the composition engine 1208 may update the table 1210 to include the data (or a portion thereof) and/or the metadata (or a portion thereof) from the component buffer 1206.

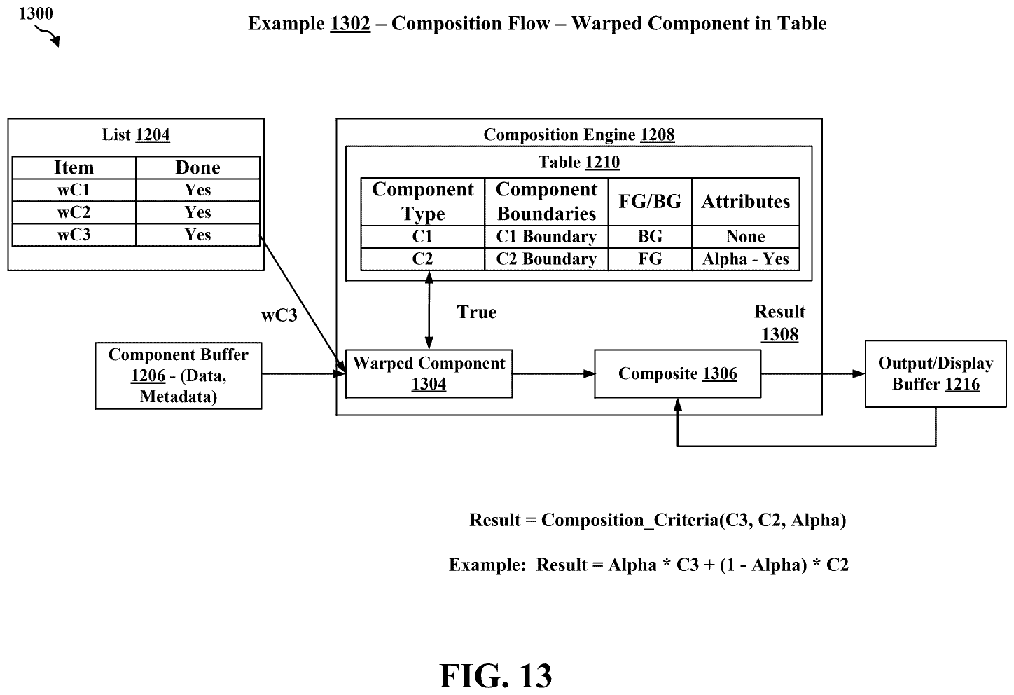

FIG. 13 is a diagram 1300 illustrating an example 1302 of a composition flow in accordance with one or more techniques of this disclosure. In the example 1302, the composition engine 1208 has processed a first warped component (wC1) and a second warped component (wC2) and has updated the table 1210 to include information pertaining to the first warped component and the second warped component.

The composition engine 1208 may read the list 1204. In an example, the composition engine 1208 may read wC3 from the list, where wC3 corresponds to a warped component 1304. The composition engine 1208 may check if the warped component 1304 has completed a warping stage. If the warped component 1304 has completed the warping stage, the warped component 1304 may be ready to be processed. The composition engine 1208 may perform a coordinate check against the table 1210 based on the warped component 1304. If the coordinate check returns results (i.e., if predicted boundary coordinates of the warped component 1212 are within or on a component boundary included in the table 1210), the composition engine 1208 may read data from the output/display buffer 1216. In an example, the data from the output/display buffer 1216 may correspond to C2 (i.e., a previously processed component). The composition engine 1208 may composite 1306 the data from the output/display buffer 1216 with the data of the warped component 1304 (i.e., generate composed data). The composition engine 1208 may write a result 1308 back to the output/display buffer 1216, where the result may be based on composition criteria and the composed data. In an example, the result 1308 may be “Result=Composition_Criteria(C3, C2, Alpha).” In another example, the result 1308 may be “Result =Alpha*C3 +(1−Alpha)*C2.” The composition engine 1208 may then update the table 1210 based on the composition.

As discussed above, the composition engine 1208 may update the table 1210. In one aspect, if a current component pointer is out of bounds with a last component boundary, a component boundary in the table 1210 may be merged with a predicted component boundary of the warped component such that a single boundary encompasses both the component boundary in the table 1210 and the predicted component boundary. In another aspect, the composition engine 1208 may maintain a first in first out (FIFO) data structure. The FIFO data structure may refer to a data structure that holds information that is processed in a first in, first out manner. The composition engine 1208 may process components in a sorted order based on the FIFO data structure. In an example, a first component may have an earliest boundary and a currently processed component may have a latest boundary. If the current component is out of bounds compared to the first component, the composition engine 1208 may evict a first entry in the table 1210. In yet another aspect, instead of waiting for warping of a current component to be completed, if a next component does not overlap with unfinished components (i.e., components that have not completed a warping process), unfinished components may be placed in a queue and the composition engine 1208 may process unfinished components when their respective warping processes complete.

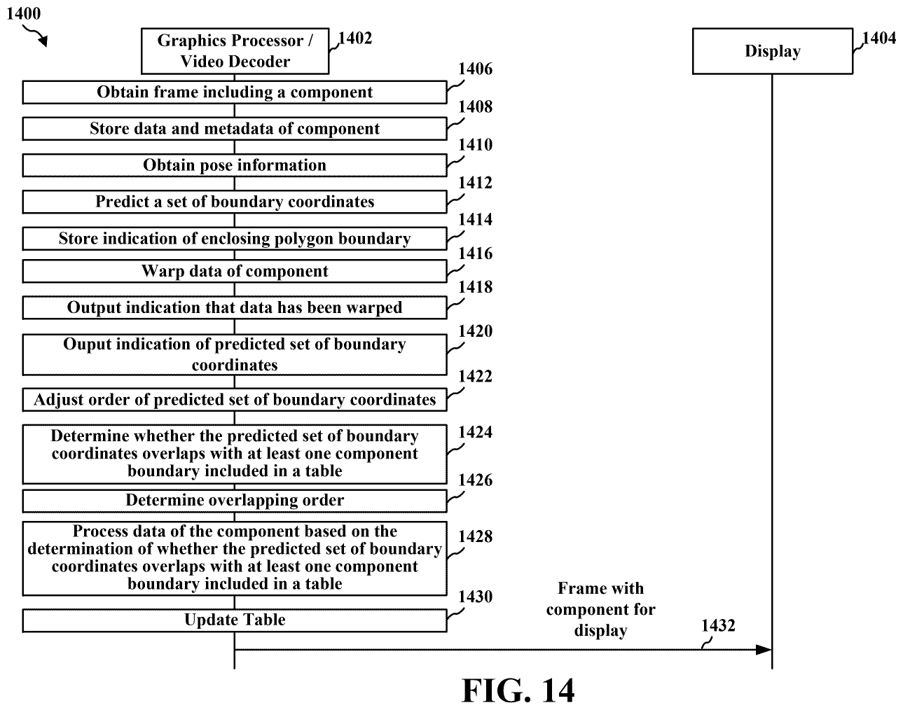

FIG. 14 is a communication flow diagram 1400 between a graphics processor/video decoder 1402 and a display 1404 in accordance with one or more techniques of this disclosure. At 1406, the graphics processor/video decoder 1402 may obtain at least one frame including at least one component, where the at least one component includes (1) data for the at least one component and (2) metadata for the at least one component, where the metadata includes enclosing boundary information of the at least one component. In one example, obtaining the at least one frame may include rendering, on a graphics processor, the at least one component of the at least one frame and the metadata for the at least one component of the at least one frame. In another example, obtaining the at least one frame may include receiving, over a wireless connection, the at least one frame, decoding the at least one frame, and extracting, based on the decoded at least one frame, the at least one component. At 1408, the graphics processor/video decoder 1402 may store the data of the at least one component and the metadata of the at least one component in at least one of a memory, a cache, or a component buffer. At 1410, the graphics processor/video decoder 1402 may obtain pose information from a headset worn by a user, where the pose information may correspond to the at least one component.

At 1412, the processor/video decoder 1402 may predict, based on the enclosing boundary information of the at least one component and pose information from a headset worn by a user corresponding to the at least one component, a set of boundary coordinates for the at least one component. Predicting the set of boundary coordinates may include warping the metadata for the at least one component based on the pose information. Warping the metadata may be based on display parameters. The metadata may further include depth boundary information of the at least one component and warping the metadata may include (1) reprojecting, based on the pose information, the enclosing boundary information and the depth boundary information and (2) transforming, based on the reprojected enclosing boundary information and the reprojected depth boundary information, the set of boundary coordinates to an enclosing polygon boundary. At 1414, the processor/video decoder 1402 may store, in a memory or a cache, an indication of the enclosing polygon boundary. At 1416, the processor/video decoder 1402 may warp the data for the at least one component based on the warped metadata for the at least one component and the pose information. At 1418, the processor/video decoder 1402 may output, for a composition engine, an indication that the data of the at least one component has been warped. At 1420, the processor/video decoder 1402 may output an indication of the predicted set of boundary coordinates of the at least one component. At 1422, the processor/video decoder 1402 may adjust, based on a display order, an order of the predicted set of boundary coordinates of the at least one component. The set of predicted boundary coordinates may be included in a list, and adjusting the order of the predicted set of boundary coordinates of the at least one component may include sort the list based on an ascending or a descending order of at least one of: a y-coordinate of boundary points associated with the at least one component or an x-coordinate of the boundary points associated with the at least one component.

At 1424, the processor/video decoder 1402 may determine whether the predicted set of boundary coordinates overlaps with at least one component boundary associated with a composition engine. Determining whether the predicted set of boundary coordinates overlaps with the at least one component boundary may include determining whether the predicted set of boundary coordinates is within or on the at least one component boundary or outside of the at least one component boundary. In one aspect, the at least one component includes at least one first component and at least one second component, where the metadata includes predicted depth boundary information associated with the at least one component and at 1426, the processor/video decoder 1402 may determine, based on the predicted depth boundary information, an overlapping order for the at least one first component and the at least one second component. The overlapping order may refer to an order in which the at least one first component and the at least one second component are to be composed (e.g., the at least one first component may be in front of the at least one second component when displayed).

At 1428, the processor/video decoder 1402 may process, based on the determination of whether the predicted set of boundary coordinates overlaps with the at least one component boundary included in the table associated with a composition engine, the data of the at least one component. In one example, processing the (warped) data for the component may include transferring, based on a first determination that a set of coordinates of the warped data of the at least one component does not overlap with the at least one component boundary of the at least one first component, a subset of the warped data of the at least one component to an output buffer, where the subset of the warped data corresponds to the set of coordinates. In another example, processing the (warped) data for the component may include reading, based on a first determination that a set of coordinates of the warped data of the at least one component overlaps with the at least one component boundary, first data from an output buffer corresponding to an overlapping portion of the set of coordinates, compositing, based on composition criteria, the first data from the output buffer and a subset of the warped data of the at least one component to the output buffer, where the subset of the warped data corresponds to the set of coordinates, and writing the composited data to the output buffer.

At 1430, the processor/video decoder 1402 may update, subsequent to the processing and based on the determination, the table. In one example, the processor/video decoder 1402 may add, based on completion of a composition of the at least one component, at least a portion of the metadata to the table. In another example, the processor/video decoder 1402 may merge the predicted set of boundary coordinates and the at least one component boundary into a single component boundary in the table. In another example, the processor/video decoder 1402 may remove, based on a first-in-first-out (FIFO) data structure, the at least one component boundary of from the table based on the at least one component boundary not overlapping with the predicted set of boundary coordinates. At 1432, the processor/video decoder 1402 may output the frame with the component for display.

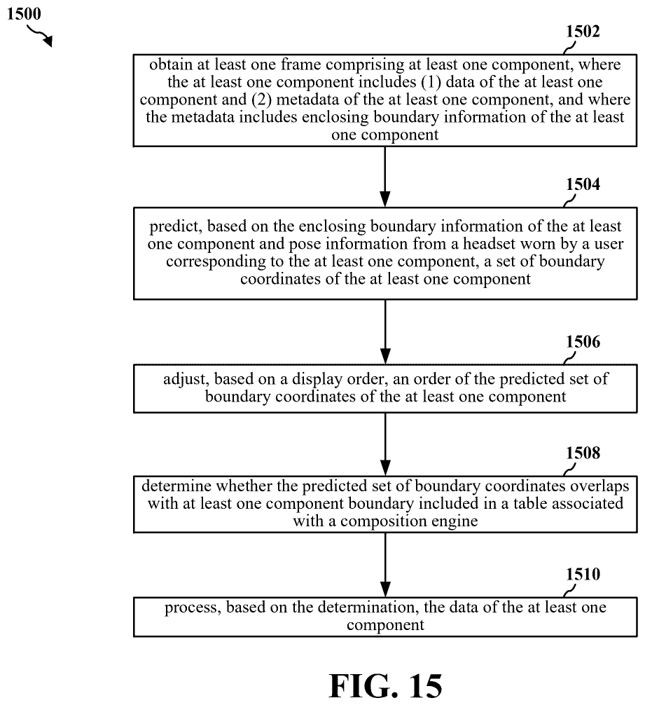

FIG. 15 is a flowchart 1500 of an example method of display processing in accordance with one or more techniques of this disclosure. The method may be performed by a graphics processor (e.g., a GPU), a video decoder, a DPU (or other display processor), an apparatus for display processing, the device 104, the WDD 406, the WDD SoC 430, a wireless communication device, and/or any apparatus that may perform display processing as used in connection with the examples of FIGS. 1-14. In an example, the method may be performed by the sparse compositor 198.

At 1502, the apparatus (e.g., a GPU) obtains at least one frame including at least one component, where the at least one component includes (1) data of the at least one component and (2) metadata of the at least one component, and where the metadata includes enclosing boundary information of the at least one component. For example, FIG. 14 at 1406 shows that the graphics processor/video decoder 1402 may obtain at least one frame including at least one component, where the at least one component includes (1) data of the at least one component and (2) metadata of the at least one component, and where the metadata includes enclosing boundary information of the at least one component. In another example, the at least one component may be or include the component 502, the data may be or include the data 504, and the metadata may be or include the metadata 506. In another example, the enclosing boundary information may be associated with the example 602 of component boundaries in FIG. 6. In an example, the at least one frame may be the first sparse frame 704 or the second sparse frame 708. In another example, the at least one component may be or include the first component 906, the data may be or include the first data 908, and the metadata may be or include the first metadata 910. In a further example, the at least one component may be or include the second component 916, the data may be or include the second data 918, and the metadata may be or include the second metadata 920. In an example, 1502 may be performed by the sparse compositor 198.

At 1504, the apparatus (e.g., a GPU) predicts, based on the enclosing boundary information of the at least one component and pose information from a headset worn by a user corresponding to the at least one component, a set of boundary coordinates of the at least one component. For example, FIG. 14 at 1412 shows that the graphics processor/video decoder 1402 may predict, based on the enclosing boundary information of the at least one component and pose information from a headset worn by a user corresponding to the at least one component, a set of boundary coordinates of the at least one component. In another example, the pose information may be the pose 934. In a further example, the headset may be or include the WDD 406. In an example, 1504 may be performed by the sparse compositor 198.

At 1506, the apparatus (e.g., a GPU) adjusts, based on a display order, an order of the predicted set of boundary coordinates of the at least one component. For example, FIG. 14 at 1422 shows that the graphics processor/video decoder 1402 may adjust, based on a display order, an order of the predicted set of boundary coordinates of the at least one component. In an example, adjusting the order may include aspects described above in connection with FIG. 11. In an example, 1506 may be performed by the sparse compositor 198.

At 1508, the apparatus (e.g., a GPU) determines whether the predicted set of boundary coordinates overlaps with at least one component boundary associated with a composition engine. For example, FIG. 14 at 1424 shows that the graphics processor/video decoder 1402 may determine whether the predicted set of boundary coordinates overlaps with at least one component boundary associated with a composition engine. In an example, the table may be or include the table 960 or the table 1210. In an example, the composition engine may be or include the composition engine 1208 or the GPU/composition engine 954. In an example, the determination may correspond to aspects described above in connection with FIG. 12 and FIG. 13. In an example, 1508 may be performed by the sparse compositor 198.

At 1510, the apparatus (e.g., a GPU) processes, based on the determination, the data of the at least one component. For example, FIG. 14 at 1428 shows that the graphics processor/video decoder 1402 may process, based on the determination, the data of the at least one component. In an example, the processing may correspond to aspects described above in connection with FIG. 12 and FIG. 13. In an example, 1510 may be performed by the sparse compositor 198.

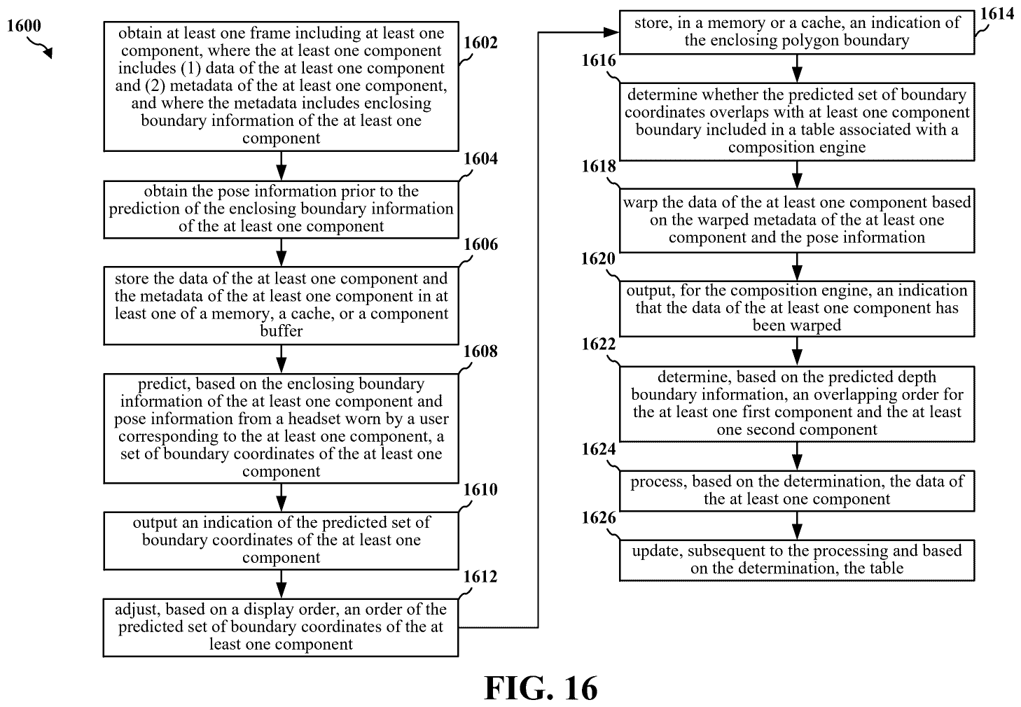

FIG. 16 is a flowchart 1600 of an example method of display processing in accordance with one or more techniques of this disclosure. The method may be performed by a graphics processor (e.g., a GPU), a video decoder, a DPU (or other display processor), an apparatus for display processing, the device 104, the WDD 406, the WDD SoC 430, a wireless communication device, and/or any apparatus that may perform display processing as used in connection with the examples of FIGS. 1-14. In an example, the method (including the various aspects detailed below) may be performed by the sparse compositor 198.

At 1602, the apparatus (e.g., a GPU) obtains at least one frame including at least one component, where the at least one component includes (1) data of the at least one component and (2) metadata of the at least one component, and where the metadata includes enclosing boundary information of the at least one component. For example, FIG. 14 at 1406 shows that the graphics processor/video decoder 1402 may obtain at least one frame including at least one component, where the at least one component includes (1) data of the at least one component and (2) metadata of the at least one component, and where the metadata includes enclosing boundary information of the at least one component. In another example, the at least one component may be or include the component 502, the data may be or include the data 504, and the metadata may be or include the metadata 506. In another example, the enclosing boundary information may be associated with the example 602 of component boundaries in FIG. 6. In an example, the at least one frame may be the first sparse frame 704 or the second sparse frame 708. In another example, the at least one component may be or include the first component 906, the data may be or include the first data 908, and the metadata may be or include the first metadata 910. In a further example, the at least one component may be or include the second component 916, the data may be or include the second data 918, and the metadata may be or include the second metadata 920. In an example, 1602 may be performed by the sparse compositor 198.

At 1608, the apparatus (e.g., a GPU) predicts, based on the enclosing boundary information of the at least one component and pose information from a headset worn by a user corresponding to the at least one component, a set of boundary coordinates of the at least one component. For example, FIG. 14 at 1412 shows that the graphics processor/video decoder 1402 may predict, based on the enclosing boundary information of the at least one component and pose information from a headset worn by a user corresponding to the at least one component, a set of boundary coordinates of the at least one component. In another example, the pose information may be the pose 934. In a further example, the headset may be or include the WDD 406. In an example, 1608 may be performed by the sparse compositor 198.

At 1612, the apparatus (e.g., a GPU) adjusts, based on a display order, an order of the predicted set of boundary coordinates of the at least one component. For example, FIG. 14 at 1422 shows that the graphics processor/video decoder 1402 may adjust, based on a display order, an order of the predicted set of boundary coordinates of the at least one component. In an example, adjusting the order may include aspects described above in connection with FIG. 11. In an example, 1612 may be performed by the sparse compositor 198.

At 1616, the apparatus (e.g., a GPU) determines whether the predicted set of boundary coordinates overlaps with at least one component boundary associated with a composition engine. For example, FIG. 14 at 1424 shows that the graphics processor/video decoder 1402 may determine whether the predicted set of boundary coordinates overlaps with at least one component boundary associated with a composition engine. In an example, the table may be or include the table 960 or the table 1210. In an example, the composition engine may be or include the composition engine 1208 or the GPU/composition engine 954. In an example, the determination may correspond to aspects described above in connection with FIG. 12 and FIG. 13. In an example, 1616 may be performed by the sparse compositor 198.

At 1624, the apparatus (e.g., a GPU) processes, based on the determination, the data of the at least one component. For example, FIG. 14 at 1428 shows that the graphics processor/video decoder 1402 may process, based on the determination, the data of the at least one component. In an example, the processing may correspond to aspects described above in connection with FIG. 12 and FIG. 13. In an example, 1624 may be performed by the sparse compositor 198.

In one aspect, at 1606, the apparatus (e.g., a GPU) may store the data of the at least one component and the metadata of the at least one component in at least one of a memory, a cache, or a component buffer. For example, FIG. 14 at 1408 shows that the graphics processor/video decoder 1402 may store the data of the at least one component and the metadata of the at least one component in at least one of a memory, a cache, or a component buffer. In another example, the component buffer may be the component buffer 1206. In an example, 1606 may be performed by the sparse compositor 198.

In one aspect, predicting the set of boundary coordinates may include warping the metadata of the at least one component based on the pose information, and determining whether the predicted set of boundary coordinates overlaps with the at least one component boundary may include determining whether the warped metadata overlaps with the at least one component boundary. For example, predicting the set of boundary coordinates at 1412 may include warping the metadata of the at least one component based on the pose information. In another example, the aforementioned aspect may correspond to the first warp/compute engine 932 and/or the second warp/compute engine 940. In another example, warping the metadata of the at least one component based on the pose information may include aspects described above in connection with FIG. 10.

In one aspect, warping the metadata of the at least one component may include warping the metadata of the at least one component additionally based on display parameters. For example, the display parameters may be or include the display parameters 936.

In one aspect, the metadata may further include depth boundary information of the at least one component, and warping the metadata based on the pose information may include: reprojecting, based on the pose information, the enclosing boundary information and the depth boundary information. For example, the aforementioned aspect may correspond to the first warp/compute engine 932 and/or the second warp/compute engine 940.

In one aspect, the metadata may further include depth boundary information of the at least one component, and warping the metadata based on the pose information may include: transforming, based on the reprojected enclosing boundary information and the reprojected depth boundary information, the set of boundary coordinates to an enclosing polygon boundary. For example, the aforementioned aspect may correspond to the first warp/compute engine 932 and/or the second warp/compute engine 940.

In one aspect, at 1614, the apparatus (e.g., a GPU) may store, in a memory or a cache, an indication of the enclosing polygon boundary. For example, FIG. 14 at 1414 shows that the graphics processor/video decoder 1402 may store, in a memory or a cache, an indication of the enclosing polygon boundary. In an example, 1614 may be performed by the sparse compositor 198.

In one aspect, at 1618, the apparatus (e.g., a GPU) may warp the data of the at least one component based on the warped metadata of the at least one component and the pose information, and where processing the data of the at least one component includes processing the warped data of the at least one component. For example, FIG. 14 at 1416 shows that the graphics processor/video decoder 1402 may warp the data of the at least one component based on the warped metadata of the at least one component and the pose information, and where processing the data of the at least one component includes processing the warped data of the at least one component. In another example, the aforementioned aspect may correspond to the first GPU/warp engine 950 or the second GPU/warp engine 956. In another example, warping the data of the at least one component based on the warped metadata of the at least one component and the pose information may include aspects described above in connection with FIG. 10. In an example, 1618 may be performed by the sparse compositor 198.

In one aspect, at 1620, the apparatus (e.g., a GPU) may output, for the composition engine, an indication that the data of the at least one component has been warped. For example, FIG. 14 at 1418 shows that the graphics processor/video decoder 1402 may output, for the composition engine, an indication that the data of the at least one component has been warped. In an example, 1620 may be performed by the sparse compositor 198.

In one aspect, processing the warped data of the at least one component may include: transferring, based on a first determination that a set of coordinates of the warped data of the at least one component does not overlap with the at least one component boundary of the at least one first component, a subset of the warped data of the at least one component to an output buffer, where the subset of the warped data corresponds to the set of coordinates. For example, processing the warped data at 1428 may include transferring, based on a first determination that a set of coordinates of the warped data of the at least one component does not overlap with the at least one component boundary of the at least one first component, a subset of the warped data of the at least one component to an output buffer, where the subset of the warped data corresponds to the set of coordinates. In another example, the aforementioned aspect may correspond to aspects described above in connection with FIG. 12. In another example, the output buffer may be the output/display buffer 1216.

In one aspect, processing the warped data of the at least one component may include: reading, based on a first determination that a set of coordinates of the warped data of the at least one component overlaps with the at least one component boundary, first data from an output buffer corresponding to an overlapping portion of the set of coordinates. For example, processing the warped data at 1428 may include reading, based on a first determination that a set of coordinates of the warped data of the at least one component overlaps with the at least one component boundary, first data from an output buffer corresponding to an overlapping portion of the set of coordinates. In another example, the aforementioned aspect may correspond to aspects described above in connection with FIG. 13. In another example, the output buffer may be the output/display buffer 1216.

In one aspect, processing the warped data of the at least one component may include: compositing, based on composition criteria, the first data from the output buffer and a subset of the warped data of the at least one component to the output buffer, where the subset of the warped data corresponds to the set of coordinates. For example, processing the warped data of the at least one component at 1428 may include compositing, based on composition criteria, the first data from the output buffer and a subset of the warped data of the at least one component to the output buffer, where the subset of the warped data corresponds to the set of coordinates. In another example, the aforementioned aspect may correspond to aspects described above in connection with FIG. 13. In another example, the aforementioned aspect may correspond to aspects described above in connection with FIG. 8.

In one aspect, processing the warped data of the at least one component may include: writing the composited data to the output buffer. For example, processing the warped data of the at least one component at 1428 may include writing the composited data to the output buffer. In another example, the aforementioned aspect may correspond to aspects described above in connection with FIG. 13.

In one aspect, determining whether the predicted set of boundary coordinates overlaps with the at least one component boundary included in the table may include: determining whether the predicted set of boundary coordinates is within or on the at least one component boundary or outside of the at least one component boundary. For example, determining whether the predicted set of boundary coordinates overlaps with the at least one component boundary included in the table at 1428 may include: determining whether the predicted set of boundary coordinates is within or on the at least one component boundary or outside of the at least one component boundary

In one aspect, at 1604, the apparatus (e.g., a GPU) may obtain the pose information prior to the prediction of the enclosing boundary information of the at least one component. For example, FIG. 14 at 1410 shows that the graphics processor/video decoder 1402 may obtain the pose information prior to the prediction of the enclosing boundary information of the at least one component. In an example, 1604 may be performed by the sparse compositor 198.

In one aspect, at 1610, the apparatus (e.g., a GPU) may output an indication of the predicted set of boundary coordinates of the at least one component. For example, FIG. 14 at 1420 shows that the graphics processor/video decoder 1402 may output an indication of the predicted set of boundary coordinates of the at least one component. In an example, 1610 may be performed by the sparse compositor 198.

In one aspect, the at least one component includes at least one first component and at least one second component, where the metadata includes predicted depth boundary information associated with the at least one component, and at 1622, the apparatus (e.g., a GPU) may determine, based on the predicted depth boundary information, an overlapping order for the at least one first component and the at least one second component, where processing the data is based on the overlapping order. For example, FIG. 14 at 1426 shows that the graphics processor/video decoder 1402 may determine, based on the predicted depth boundary information, an overlapping order for the at least one first component and the at least one second component, where processing the data is based on the overlapping order. In an example, the at least one first component may be or include the first component 906 and the at least one second component may be or include the second component 916. In an example, 1622 may be performed by the sparse compositor 198.

In one aspect, determining the overlapping order for the at least one first component and the at least one second component may include determining, based on the predicted depth boundary information, that a first depth boundary of the at least one first component does not intersect with a second depth boundary of the at least one second component. For example, determining the overlapping order for the at least one first component and the at least one second component at 1426 may include determining, based on the predicted depth boundary information, that a first depth boundary of the at least one first component does not intersect with a second depth boundary of the at least one second component.

In one aspect, determining the overlapping order for the at least one first component and the at least one second component may include adjusting, based on the predicted depth boundary information, the overlapping order based on an increasing or a decreasing order associated with the predicted depth boundary information. For example, determining the overlapping order for the at least one first component and the at least one second component at 1426 may include adjusting, based on the predicted depth boundary information, the overlapping order based on an increasing or a decreasing order associated with the predicted depth boundary information.

In one aspect, the table associated with the composition engine may further include at least one of: a type of at least one first component corresponding to the at least one component boundary, an indication of an overlapping order of the at least one first component, or at least one attribute of the at least one first component, and where processing the data of the at least one component may be further based on at least one of: the type of the at least one first component, the at least one component boundary of the at least one first component, the indication of the overlapping order of the at least one first component, or the at least one attribute of the at least one first component. For example, the aforementioned aspect may correspond to the table 1210 described above in connection with FIGS. 12 and 13.

In one aspect, the predicted set of boundary coordinates may be included in a list, and adjusting the order of the predicted set of boundary coordinates may include: sorting the list based on an ascending or a descending order of at least one of: a y-coordinate of boundary points associated with the at least one component or an x-coordinate of the boundary points associated with the at least one component. In an example, the list may be or include the list 946 or the list 1204. In another example, the aforementioned aspect may correspond to aspects described above in connection with FIG. 11.

In one aspect, at 1626, the apparatus (e.g., a GPU) may update, subsequent to the processing and based on the determination, the table. For example, FIG. 14 at 1430 shows that the graphics processor/video decoder 1402 may update, subsequent to the processing and based on the determination, the table. In an example, 1626 may be performed by the sparse compositor 198.

In one aspect, updating the table may include: adding, based on completion of a composition of the at least one component, at least a portion of the metadata to the table. For example, updating the table at 1430 may include: adding, based on completion of a composition of the at least one component, at least a portion of the metadata to the table

In one aspect, updating the table may include: merging the predicted set of boundary coordinates and the at least one component boundary into a single component boundary in the table. For example, updating the table at 1430 may include: merging the predicted set of boundary coordinates and the at least one component boundary into a single component boundary in the table.

In one aspect, updating the table may include: removing, based on a first-in-first-out (FIFO) data structure, the at least one component boundary of from the table based on the at least one component boundary not overlapping with the predicted set of boundary coordinates. For example, updating the table at 1430 may include removing, based on a first-in-first-out (FIFO) data structure, the at least one component boundary of from the table based on the at least one component boundary not overlapping with the predicted set of boundary coordinates.

In one aspect, the data of the at least one component of the at least one frame may include one of color information or gray scale information. For example, the data 504 may include one of color information or gray scale information.

In one aspect, the data of the at least one component of the at least one frame further may include at least one of: depth information of the at least one component, or an alpha level of the at least one component. For example, the data 504 may include at least one of: depth information of the at least one component, or an alpha level of the at least one component.

In one aspect, the metadata of the at least one component of the at least one frame may include at least one of: a depth indication of the at least one component, a depth boundary of the at least one component, an indication of alpha information of the at least one component, a component type of the at least one component, or composition criteria. For example, the metadata 506 may include at least one of: a depth indication of the at least one component, a depth boundary of the at least one component, an indication of alpha information of the at least one component, a component type of the at least one component, or composition criteria.

In one aspect, obtaining the at least one frame including the at least one component may include: rendering, on a graphics processor, the at least one component of the at least one frame and the metadata of the at least one component of the at least one frame. For example, obtaining the at least one frame including the at least one component at 1406 may include: rendering, on a graphics processor, the at least one component of the at least one frame and the metadata of the at least one component of the at least one frame. In another example, FIG. 9 shows that the GPU 904 may render the first component 906 and the third component 926.

In one aspect, obtaining the at least one frame including the at least one component may include: receiving, over a wireless connection, the at least one frame. For example, obtaining the at least one frame including the at least one component at 1406 may include: receiving, over a wireless connection, the at least one frame. In another example, FIG. 9 shows that the second component 916 may be obtained over a wireless connection. In a further example, the wireless connection may be the link 408.

In one aspect, obtaining the at least one frame including the at least one component may include: decoding the at least one frame. For example, obtaining the at least one frame including the at least one component at 1406 may include: decoding the at least one frame. For example, FIG. 4 at 434 shows that the WDD SoC 430 may decode a frame.

In one aspect, obtaining the at least one frame including the at least one component may include: extracting, based on the decoded at least one frame, the at least one component. For example, obtaining the at least one frame including the at least one component at 1406 may include: extracting, based on the decoded at least one frame, the at least one component.

A split XR system may include a companion device (e.g., a phone) and a wearable display device (e.g., a HMD), where the companion device and the wearable display device may exchange data in order to facilitate the display of content on the wearable display device. In some aspects, the companion device may have a greater amount of computational power in comparison to an amount of computational power of the wearable display device. In some split XR systems, the wearable display device may operate in standalone mode or in companion mode. In a standalone mode, the wearable display device may operate independently of the companion device. For example, the wearable display device may render frames and display the frames without transmitting or receiving data to/from the companion device. In a companion mode, the wearable display device may exchange data with the companion device in order to facilitate the display of content on the wearable display device. For example, the companion device may render frames and transmit the frames to the wearable display device. The wearable display device may receive the frames, process the frames, and present the processed frames for display.

A wearable display device may perform a reprojection based on latest available pose information of the wearable display device to account for changes in movement of the wearable display device between a time at which content is rendered and a time at which the content is to be displayed. A reprojection may include a warping process and a composition process. Warping process may refer to adjusting values in an eye buffer based on latest available pose information. A composition process may refer to ordering layers of a frame based on the latest available pose information. There may be different types of warping processes (e.g., a sparse warp process, a full-screen warp process, etc.) and different types of composition processes (e.g., a sparse composition process, a full-screen composition process, etc.). As used herein, an adaptive reprojection mode may include a warping process and a composition process.

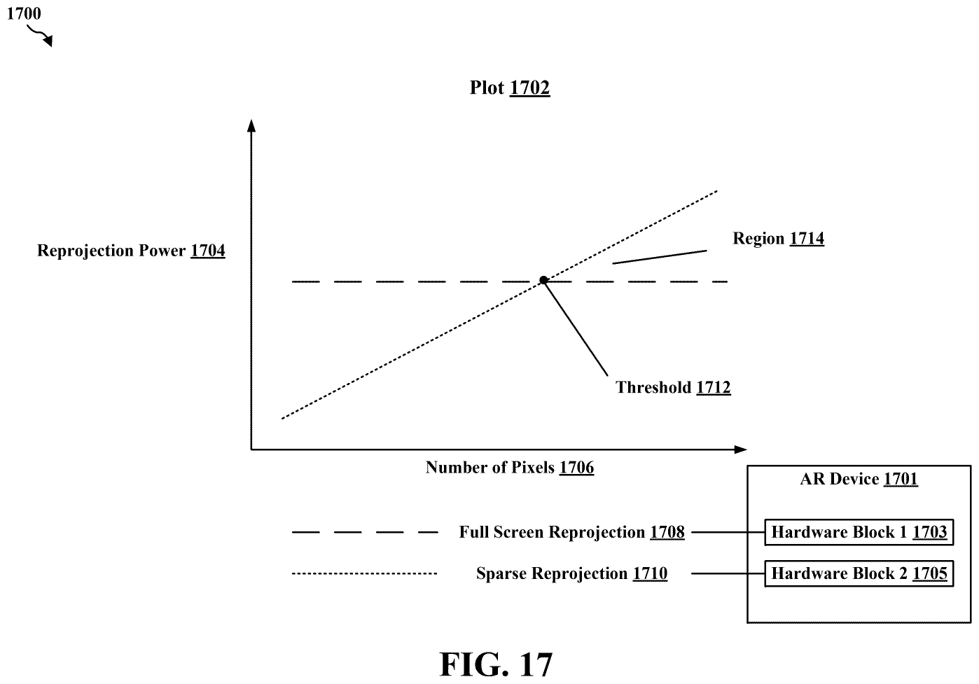

FIG. 17 is a diagram 1700 illustrating example aspects of augmented reality in accordance with one or more techniques of this disclosure. Augmented reality (AR) may refer to the augmentation of the real (physical) world with virtual content. Example AR application may include room designing or virtual shopping, table top AR games, turn-by-turn navigation assistance, food and health monitoring, AR video calls, and/or virtual meetings. AR may be accomplished with a wearable AR device capable of mapping the physical world, localizing the wearable AR device in the physical world, and positioning and/or rendering virtual content on a near-eye display visible to a user. Some AR devices may utilize hand/fingertip tracking to allow users to control interfaces in AR.

In certain instances, a majority of AR content may be sparse content. In other instances, a majority of AR content may not be sparse content. For example, AR content may include a clock on a wall, where the clock may be sparse if a user is located relatively far away from the clock. However, if a user physically walks to a location of the clock on the wall, such that the user is located relatively close to the clock, the clock may occupy a larger field-of-view (FoV) of the user compared to a field-of-view of the user when the user was located relatively far away from the clock. Thus, the clock may no longer be sparse. An AR device may include hardware block(s) that may be configured with a power-differentiated sparse mode that offers improved power performance for reprojecting and/or composing sparse AR content, but decreased power performance for reprojecting and/or composing full screen content.

The diagram 1700 depicts a plot 1702 of reprojection power 1704 utilized by an AR device for reprojection versus a number of pixels 1706 reprojected. The plot 1702 includes a first line corresponding to a full screen reprojection 1708 and a second line corresponding to a sparse reprojection 1710. In an example, the full screen reprojection 1708 may be performed by and/or associated with a first hardware block 1703 of an AR device 1701 (e.g., the device 104, the WDD 406) and the sparse reprojection 1710 may be performed by a second hardware block 1705 of the AR device 1701, where the first hardware block 1703 may include different characteristics compared to the characteristics of the second hardware block 1705. A hardware block may refer to hardware that is configured for a particular purpose. The AR device 1701 may be, or may include, a head mounted display (HMD). As illustrated in the plot 1702, the reprojection power 1704 (i.e., power consumed while performing a reprojection) for the full screen reprojection 1708 may remain constant as the number of pixels 1706 that is reprojected increases. Furthermore, the reprojection power 1704 for the sparse reprojection 1710 may increase (e.g., linearly increase) as the number of pixels 1706 reprojected increases. Thus, when the number of pixels 1706 reprojected is below a threshold 1712 (i.e., a threshold number of pixels), the first hardware block 1703 may offer improved performance compared to a performance of the second hardware block 1705 and when the number of pixels 1706 reprojected is above the threshold 1712, the second hardware block 1705 may offer improved performance compared to a performance of the first hardware block 1703. As a result, the plot 1702 may include a region 1714 in which the sparse reprojection 1710 has decreased performance compared to performance of the full screen reprojection 1708.

In one aspect, the first hardware block 1703 may be further configured to perform a full screen composition in addition to the full screen reprojection 1708 and the second hardware block may be further configured to perform a sparse composition in addition to the sparse reprojection 1710. In another aspect, a third hardware block (not depicted in FIG. 17) of the AR device 1701 may be configured to perform the full screen composition and a fourth hardware block (not depicted in FIG. 17) of the AR device 1701 may be configured to perform the sparse composition.

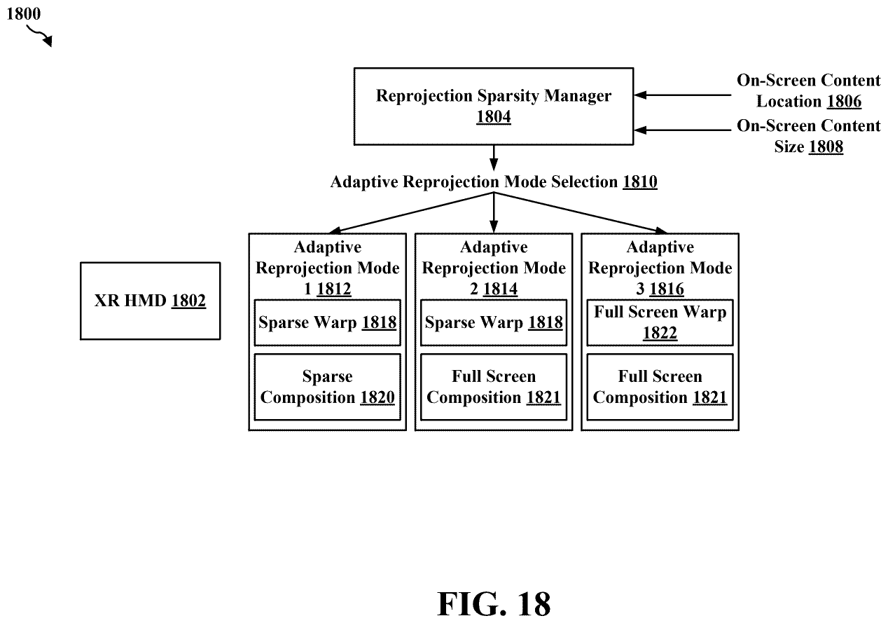

FIG. 18 is a diagram 1800 illustrating aspects of managing adaptive reprojection in accordance with one or more techniques of this disclosure. An XR HMD 1802 may include a reprojection sparsity manager 1804. The XR HMD 1802 may be, or may include, the device 104, the WDD 406, and/or the AR device 1701. In an example, the XR HMD 1802 may be in communication with a companion device (not depicted in FIG. 18) via a wired link or a wireless link. In an example, the wireless link may be a wireless local area network (WLAN) link, such as an Institute of Electrical and Electronics Engineers (IEEE) 802.11ax 6 GHz link. The reprojection sparsity manager 1804 may be configured to manage a sparsity of on-chip reprojection. The reprojection sparsity manager 1804 may be implemented in hardware, software, and/or firmware. In one example, the reprojection sparsity manager 1804 may be, or may include, a DPU. In another example, the reprojection sparsity manager 1804 may be, or may include, a GPU. In yet another example, the reprojection sparsity manager 1804 may be, or may include, a hardware block.

The reprojection sparsity manager 1804 may obtain an on-screen content location 1806 (i.e., a location of on-screen content (e.g., XR content)) and/or an on-screen content size 1808 (i.e., a size of on-screen content (e.g., XR content)). The reprojection sparsity manager 1804 may determine whether or not content (e.g., XR content) is sparse based on the on-screen content location 1806 and/or the on-screen content size 1808. Additionally, or alternatively, the reprojection sparsity manager 1804 may determine whether a predicted composition of content will occupy a field of view (FoV) of a user that is larger than a threshold FoV (e.g., a threshold percentage of a FoV). The reprojection sparsity manager 1804 may select an adaptive reprojection mode selection 1810 based on the determination, that is, the reprojection sparsity manager 1804 may select an adaptive reprojection mode from amongst a set of adaptive reprojection modes based on the determination. An adaptive reprojection mode may include a warp (e.g., a sparse warp or a full screen warp) and/or a composition (e.g., a sparse composition or a full screen composition). The XR HMD 1802 may perform a warp and/or a composition indicated in the selected adaptive reprojection mode. The XR HMD 1802 may display the on-screen content (e.g., warped and/or composited content) subsequent to performing the warp and/or the composition.

In an example, the reprojection sparsity manager 1804 may select from a first adaptive reprojection mode 1812, a second adaptive reprojection mode 1814, or a third adaptive reprojection mode 1816 based on the determination. The first adaptive reprojection mode 1812, the second adaptive reprojection mode 1814, and the third adaptive reprojection mode 1816 may be collectively referred to as a “set of adaptive reprojection modes 1812-1816.”

In one example, the reprojection sparsity manager 1804 may determine that the on-screen content is sparse. The reprojection sparsity manager 1804 may select the first adaptive reprojection mode 1812 based on the determination, where the first adaptive reprojection mode 1812 may include a sparse warp 1818 and a sparse composition 1820. The XR HMD 1802 may perform the sparse warp 1818 and the sparse composition 1820 on the on-screen content based on the selection. In an example, the second hardware block 1705 may perform the sparse warp 1818 and the sparse composition 1820.

In another example, the reprojection sparsity manager 1804 may determine that the on-screen content is sparse and that a predicted composition of the on-screen content may occupy a FoV of a user that is larger than a threshold FoV. The reprojection sparsity manager 1804 may select the second adaptive reprojection mode 1814 based on the determination, where the second adaptive reprojection mode 1814 may include the sparse warp 1818 and a full screen composition 1821. In an example, the second hardware block 1705 may perform the sparse warp 1818 and the first hardware block 1703 may perform the full screen composition 1821.

In yet another example, the reprojection sparsity manager 1804 may determine that a predicted composition of the on-screen content will occupy a FoV of a user that is larger than a threshold FoV. The reprojection sparsity manager 1804 may select the third adaptive reprojection mode 1816 based on the determination, where the third adaptive reprojection mode 1816 may include a full screen warp 1822 and the full screen composition 1821. In an example, the first hardware block 1703 may perform the full screen warp 1822 and the full screen composition 1821.

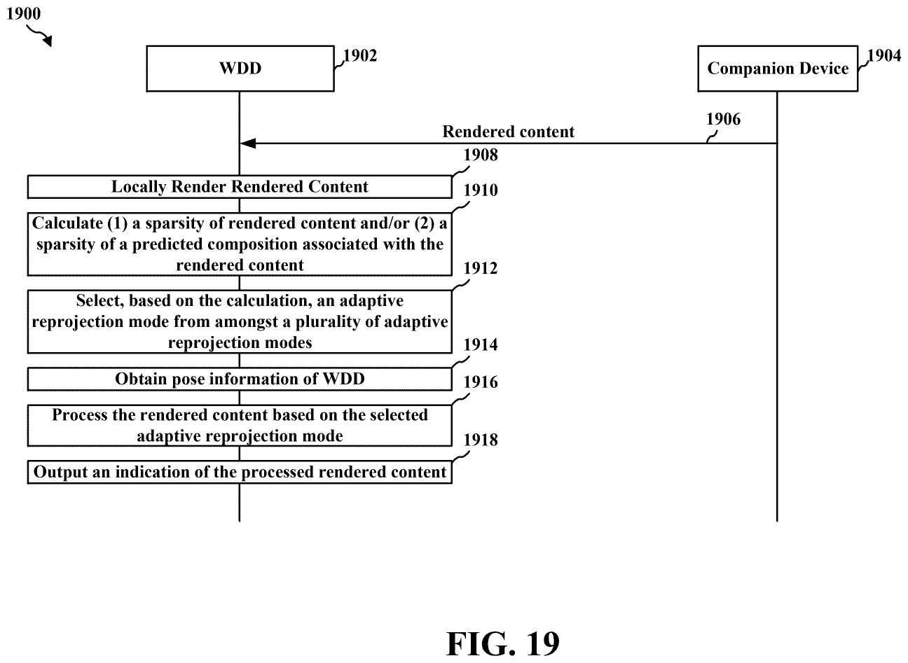

FIG. 19 is a communication flow diagram 1900 between a wearable display device (WDD) 1902 and a companion device 1904 in accordance with one or more techniques of this disclosure. In an example, the WDD 1902 may be, or may include, the device 104, the WDD 406, or the XR HMD 1802. In an example, the companion device 1904 may be, or may include, the device 104 or the companion device 404.

At 1910, the WDD 1902 may calculate at least one of (1) a sparsity of rendered content or (2) a sparsity of a predicted composition associated with the rendered content. At 1912, the WDD 1902 may select, based on the calculation, an adaptive reprojection mode from amongst a plurality of adaptive reprojection modes. At 1916, the WDD 1902 may process the rendered content based on the selected adaptive reprojection mode. At 1918, the WDD 1902 may output an indication of the processed rendered content.

In one aspect, at 1906, the WDD 1902 may receive, from a companion device (e.g., the companion device 1904), the rendered content, where the calculation at 1910 may be based on the received rendered content. In another aspect, at 1908, the WDD 1902 may locally render the rendered content prior to the calculation, where the calculation at 1910 may be based on the locally rendered content. At 1914, the WDD 1902 may obtain pose information of a wearable display device, where processing the rendered content based on the selected adaptive reprojection mode at 1916 may include processing the rendered content further based on the pose information.

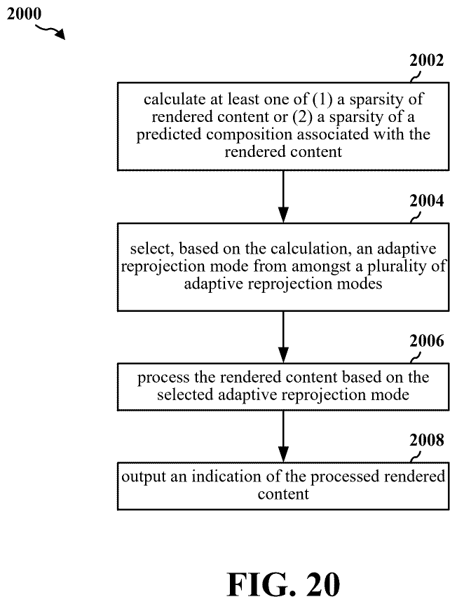

FIG. 20 is a flowchart 2000 of an example method of display processing in accordance with one or more techniques of this disclosure. The method may be performed by an apparatus, such as an apparatus for display processing, a CPU, a display processing unit (DPU) or other display processor, a graphics processor (e.g., a GPU), a wearable display device (e.g., the XR HMD 1802), the AR device 1701, the device 104, a wireless communication device, and the like, as used in connection with the aspects of FIGS. 1-4, 7-8, and 17-19. In an example, the method may be performed by the reprojection manager 199.

At 2002, the apparatus (e.g., a wearable display device) calculates at least one of (1) a sparsity of rendered content or (2) a sparsity of a predicted composition associated with the rendered content. For example, FIG. 19 at 1910 shows that the WDD 1902 may calculate at least one of (1) a sparsity of rendered content or (2) a sparsity of a predicted composition associated with the rendered content. In an example, the sparsity of the rendered content may be associated with aspects described above in connection to FIG. 7 and the sparsity of the predicted composition may be associated with aspects described above in connection with FIG. 8. In an example, the aforementioned calculation may be associated with aspects described above in connection FIG. 18. In an example, 2002 may be performed by the reprojection manager 199.

At 2004, the apparatus (e.g., a wearable display device) selects, based on the calculation, an adaptive reprojection mode from amongst a plurality of adaptive reprojection modes. For example, FIG. 19 at 1912 shows that the WDD 1902 may select, based on the calculation, an adaptive reprojection mode from amongst a plurality of adaptive reprojection modes. In an example, the plurality of adaptive reprojection modes may be, or may include, the set of adaptive reprojection modes 1812-1816. For instance, the WDD 1902 may select the first adaptive reprojection mode 1812. In an example, 2004 may be performed by the reprojection manager 199.

At 2006, the apparatus (e.g., a wearable display device) processes the rendered content based on the selected adaptive reprojection mode. For example, FIG. 19 at 1916 shows that the WDD 1902 may process the rendered content based on the selected adaptive reprojection mode. In an example, 2006 may be performed by the reprojection manager 199.

At 2008, the apparatus (e.g., a wearable display device) outputs an indication of the processed rendered content. For example, FIG. 19 at 1918 shows that the WDD 1902 may output an indication of the processed rendered content. In an example, 2008 may be performed by the reprojection manager 199.

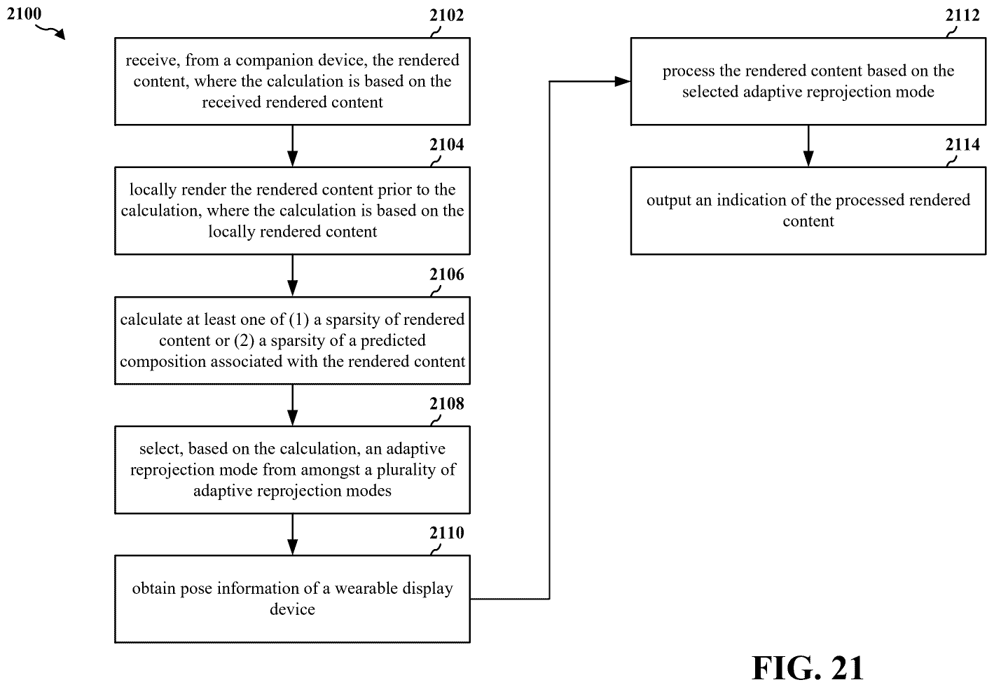

FIG. 21 is a flowchart 2100 of an example method of display processing in accordance with one or more techniques of this disclosure. The method may be performed by an apparatus, such as an apparatus for display processing, a CPU, a display processing unit (DPU) or other display processor, a graphics processor (e.g., a GPU), a wearable display device (e.g., the XR HMD 1802), the AR device 1701, the device 104, a wireless communication device, and the like, as used in connection with the aspects of FIGS. 1-4, 7-8, and 17-19. In an example, the method (including the various aspects detailed below) may be performed by the reprojection manager 199.

At 2106, the apparatus (e.g., a wearable display device) calculates at least one of (1) a sparsity of rendered content or (2) a sparsity of a predicted composition associated with the rendered content. For example, FIG. 19 at 1910 shows that the WDD 1902 may calculate at least one of (1) a sparsity of rendered content or (2) a sparsity of a predicted composition associated with the rendered content. In an example, the sparsity of the rendered content may be associated with aspects described above in connection to FIG. 7 and the sparsity of the predicted composition may be associated with aspects described above in connection with FIG. 8. In an example, the aforementioned calculation may be associated with aspects described above in connection FIG. 18. In an example, 2106 may be performed by the reprojection manager 199.

At 2108, the apparatus (e.g., a wearable display device) selects, based on the calculation, an adaptive reprojection mode from amongst a plurality of adaptive reprojection modes. For example, FIG. 19 at 1912 shows that the WDD 1902 may select, based on the calculation, an adaptive reprojection mode from amongst a plurality of adaptive reprojection modes. In an example, the plurality of adaptive reprojection modes may be or include the set of adaptive reprojection modes 1812-1816. For instance, the WDD 1902 may select the first adaptive reprojection mode 1812. In an example, 2108 may be performed by the reprojection manager 199.

At 2112, the apparatus (e.g., a wearable display device) processes the rendered content based on the selected adaptive reprojection mode. For example, FIG. 19 at 1916 shows that the WDD 1902 may process the rendered content based on the selected adaptive reprojection mode. In an example, 2112 may be performed by the reprojection manager 199.

At 2114, the apparatus (e.g., a wearable display device) outputs an indication of the processed rendered content. For example, FIG. 19 at 1918 shows that the WDD 1902 may output an indication of the processed rendered content. In an example, 2114 may be performed by the reprojection manager 199.

In one aspect, each of the plurality of adaptive reprojection modes may include a warping process and a composition process. For example, FIG. 18 shows that each of the plurality of adaptive reprojection modes may include a warping process and a composition process.

In one aspect, the warping process may be one of a sparse warp process or a full screen warp process, and where the composition process may be one of a sparse composition process or a full screen composition process. For example, the sparse warp process may be or include the sparse warp 1818 and the full screen warp process may be or include the full screen warp 1822. In another example, the sparse composition process may be or include the sparse composition 1820 and the full screen composition process may be or include the full screen composition 1821.

In one aspect, the warping process may be associated with a first sparsity level of a plurality of sparsity levels, and where the composition process may be associated with a second sparsity level of the plurality of sparsity levels. For example, sparse warp 1818 may be associated with a first sparsity level of a plurality of sparsity levels and the full screen composition 1821 may be associated with a second sparsity level of the plurality of sparsity level.

In one aspect, processing the rendered content based on the selected adaptive reprojection mode may include executing an image warp on the rendered content, where the image warp may be associated with the selected adaptive reprojection mode. For example, processing the rendered content based on the selected adaptive reprojection mode at 1916 may include executing an image warp on the rendered content, where the image warp may be associated with the selected adaptive reprojection mode.

In one aspect, outputting the indication of the processed rendered content may include storing the indication of the processed rendered content in a memory, a buffer, or a cache. For example, outputting the indication of the processed rendered content at 1918 may include storing the indication of the processed rendered content in a memory, a buffer, or a cache.

In one aspect, outputting the indication of the processed rendered content may include transmitting the processed rendered content for display on at least one display panel. For example, outputting the indication of the processed rendered content at 1918 may include transmitting the processed rendered content for display on at least one display panel. In an example, the at least one display panel may be or include the display(s) 131.

In one aspect, calculating at least one of (1) the sparsity of the rendered content or (2) the sparsity of the predicted composition associated with the rendered content may include computing a percentage of a display panel that is to be occupied by the rendered content, and selecting the adaptive reprojection mode may include selecting the adaptive reprojection mode based on the computed percentage and a threshold display percentage. For example, the aforementioned aspect may correspond to the description of FIG. 18 above.

In one aspect, each of the plurality of adaptive reprojection modes may be associated with a different hardware block of a wearable display device. For example, the aforementioned aspect may correspond to the first hardware block 1703 and the second hardware block 1705. In an example, the wearable display device may be or include the device 104, the AR device 1701, and/or the XR HMD 1802.

In one aspect, a first adaptive reprojection mode in the plurality of adaptive reprojection modes may be associated with a first power consumption, and a second adaptive reprojection mode in the plurality of adaptive reprojection modes may be associated with a second power consumption that is different from the first power consumption. For example, the first adaptive reprojection mode 1812 may be associated with a first power consumption and the second adaptive reprojection mode 1814 may be associated with a second power consumption that is different from the first power consumption.

In one aspect, the first power consumption may be based on a number of pixels that are reprojected, and the second power consumption may not be based on the number of pixels that are reprojected. For example, the first power consumption may be associated with the sparse reprojection 1710 and the second power consumption may be associated with the full screen reprojection 1708.

In one aspect, the first power consumption and the second power consumption may be based on a number of pixels that are reprojected, and, for a first sparsity level, the first power consumption may be less than the second power consumption, and, for a second sparsity level, the first power consumption may be greater than the second power consumption. For example, the aforementioned aspect may be associated with the description of FIG. 17 above.

In one aspect, calculating at least one of (1) the sparsity of the rendered content or (2) the sparsity of the predicted composition associated with the rendered content may include determining at least one of a location of the rendered content on a display panel or a size of the rendered content on the display panel, and selecting the adaptive reprojection mode may include selecting the adaptive reprojection mode based on at least one of the location of the rendered content on the display panel or the size of the rendered content on the display panel. For example, calculating at least one of (1) the sparsity of the rendered content or (2) the sparsity of the predicted composition associated with the rendered content at 1910 may include determining at least one of a location of the rendered content on a display panel or a size of the rendered content on the display panel, and selecting the adaptive reprojection mode at 1912 may include selecting the adaptive reprojection mode based on at least one of the location of the rendered content on the display panel or the size of the rendered content on the display panel. In an example, the location of rendered content may correspond to the on-screen content location 1806 and the size of the rendered content may correspond to the on-screen content size 1808.

In one aspect, the rendered content may include a first rendered frame for a right eye of a user and a second rendered frame for a left eye of the user, and processing the rendered content based on the selected adaptive reprojection mode may include processing the first rendered frame and the second rendered frame based on the selected adaptive reprojection mode. For example, the first rendered frame for the right eye of the user may correspond to the REF 416 and the second rendered frame for the left eye of the user may correspond to the LEF 414. In another example, processing the rendered content based on the selected adaptive reprojection mode at 1916 may include processing the first rendered frame and the second rendered frame based on the selected adaptive reprojection mode.

In one aspect, at 2102, the apparatus (e.g., a wearable display device) may receive, from a companion device, the rendered content, where the calculation may be based on the received rendered content. For example, FIG. 19 at 1906 shows that the WDD 1902 may receive, from a companion device (e.g., the companion device 1904), the rendered content, where the calculation at 1910 may be based on the received rendered content. In an example, the companion device may be or include the companion device 404. In an example, 2102 may be performed by the reprojection manager 199.

In one aspect, at 2104, the apparatus (e.g., a wearable display device) may locally render the rendered content prior to the calculation, and the calculation may be based on the locally rendered content. For example, FIG. 19 at 1908 shows that the WDD 1902 may locally render the rendered content prior to the calculation at 1910, and the calculation at 1910 may be based on the locally rendered content. In an example, 2104 may be performed by the reprojection manager 199.

In one aspect, at 2110, the apparatus (e.g., a wearable display device) may obtain pose information of a wearable display device, where processing the rendered content based on the selected adaptive reprojection mode may include processing the rendered content further based on the pose information. For example, FIG. 19 at 1914 shows that the WDD 1902 may obtain pose information of a wearable display device, where processing the rendered content based on the selected adaptive reprojection mode at 1916 may include processing the rendered content further based on the pose information. In an example, 2110 may be performed by the reprojection manager 199.

In one aspect, the rendered content may be at least one of: rendered extended reality (XR), rendered augmented reality (AR) content, rendered mixed reality (MR) content, or rendered virtual reality (VR) content. For example, the rendered content at 1910 may be at least one of: rendered extended reality (XR), rendered augmented reality (AR) content, rendered mixed reality (MR) content, or rendered virtual reality (VR) content.

In configurations, a method or an apparatus for display processing is provided. The apparatus may be a DPU (or other display processor), a GPU (or other graphics processor), a CPU (or other central processor), a display driver integrated circuit (DDIC), an apparatus for display processing, and/or some other processor that may perform display processing. In aspects, the apparatus may be the processing unit 120 or the display processor 127 within the device 104, or may be some other hardware within the device 104 or another device. The apparatus may include means for obtaining at least one frame including at least one component, where the at least one component includes (1) data of the at least one component and (2) metadata of the at least one component, and where the metadata includes enclosing boundary information of the at least one component. The apparatus may include means for predicting, based on the enclosing boundary information of the at least one component and pose information from a headset worn by a user corresponding to the at least one component, a set of boundary coordinates of the at least one component. The apparatus may include means for adjusting, based on a display order, an order of the predicted set of boundary coordinates of the at least one component. The apparatus may include means for determining whether the predicted set of boundary coordinates overlaps with at least one component boundary associated with a composition engine. The apparatus may include means for processing, based on the determination, the data of the at least one component. The apparatus may include means for storing the data of the at least one component and the metadata of the at least one component in at least one of a memory, a cache, or a component buffer. The apparatus may include means for storing, in a memory or a cache, an indication of the enclosing polygon boundary. The apparatus may include means for warping the data of the at least one component based on the warped metadata of the at least one component and the pose information, and where processing the data of the at least one component includes processing the warped data of the at least one component. The apparatus may include means for outputting, for the composition engine, an indication that the data of the at least one component has been warped. The apparatus may include means for obtaining the pose information prior to the prediction of the enclosing boundary information of the at least one component. The apparatus may include means for outputting an indication of the predicted set of boundary coordinates of the at least one component. The apparatus may include means for determining, based on the predicted depth boundary information, an overlapping order for the at least one first component and the at least one second component, where processing the data is based on the overlapping order. The apparatus may include means for updating, subsequent to the processing and based on the determination, the table.

In configurations, a method or an apparatus for display processing is provided. The apparatus may be a DPU (or other display processor), a GPU (or other graphics processor), a CPU (or other central processor), a display driver integrated circuit (DDIC), an apparatus for display processing, and/or some other processor that may perform display processing. In aspects, the apparatus may be the processing unit 120 or the display processor 127 within the device 104, or may be some other hardware within the device 104 or another device. The apparatus may include means for calculating at least one of (1) a sparsity of rendered content or (2) a sparsity of a predicted composition associated with the rendered content. The apparatus may include means for selecting, based on the calculation, an adaptive reprojection mode from amongst a plurality of adaptive reprojection modes. The apparatus may include means for processing the rendered content based on the selected adaptive reprojection mode. The apparatus may include means for outputting an indication of the processed rendered content. The apparatus may include means for receiving, from a companion device, the rendered content, where the calculation is based on the received rendered content. The apparatus may include means for locally rendering the rendered content prior to the calculation, where the calculation is based on the locally rendered content. The apparatus may include means for obtaining pose information of a wearable display device, where processing the rendered content based on the selected adaptive reprojection mode includes processing the rendered content further based on the pose information.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may include RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.
Aspect 1 a method of display processing, comprising: obtaining at least one frame comprising at least one component, wherein the at least one component comprises (1) data of the at least one component and (2) metadata of the at least one component, and wherein the metadata comprises enclosing boundary information of the at least one component; predicting, based on the enclosing boundary information of the at least one component and pose information from a headset worn by a user corresponding to the at least one component, a set of boundary coordinates of the at least one component; adjusting, based on a display order, an order of the predicted set of boundary coordinates of the at least one component; determining whether the predicted set of boundary coordinates overlaps with at least one component boundary associated with a composition engine; and processing, based on the determination, the data of the at least one component.
Aspect 2 may be combined with aspect 1 and further comprises storing the data of the at least one component and the metadata of the at least one component in at least one of a memory, a cache, or a component buffer.
Aspect 3 may be combined with any of aspects 1-2 and comprises that predicting the set of boundary coordinates comprises warping the metadata of the at least one component based on the pose information, and wherein determining whether the predicted set of boundary coordinates overlaps with the at least one component boundary comprises determining whether the warped metadata overlaps with the at least one component boundary.
Aspect 4 may be combined with aspect 3 and comprises that warping the metadata of the at least one component comprises warping the metadata of the at least one component additionally based on display parameters.
Aspect 5 may be combined with any of aspects 3-4 and comprises that the metadata may further include depth boundary information of the at least one component, wherein warping the metadata based on the pose information comprises: reprojecting, based on the pose information, the enclosing boundary information and the depth boundary information; and transforming, based on the reprojected enclosing boundary information and the reprojected depth boundary information, the set of boundary coordinates to an enclosing polygon boundary.
Aspect 6 may be combined with aspect 5 and further comprises storing, in a memory or a cache, an indication of the enclosing polygon boundary.
Aspect 7 may be combined with any of aspects 3-6 and further comprises warping the data of the at least one component based on the warped metadata of the at least one component and the pose information, and wherein processing the data of the at least one component comprises processing the warped data of the at least one component.
Aspect 8 may be combined with aspect 7 and further comprises outputting, for the composition engine, an indication that the data of the at least one component has been warped.
Aspect 9 may be combined with any of aspects 7-8 and comprises that processing the warped data of the at least one component comprises: transferring, based on a first determination that a set of coordinates of the warped data of the at least one component does not overlap with the at least one component boundary of the at least one first component, a subset of the warped data of the at least one component to an output buffer, wherein the subset of the warped data corresponds to the set of coordinates.
Aspect 10 may be combined with any of aspects 7-8 and comprises that processing the warped data of the at least one component comprises: reading, based on a first determination that a set of coordinates of the warped data of the at least one component overlaps with the at least one component boundary, first data from an output buffer corresponding to an overlapping portion of the set of coordinates; compositing, based on composition criteria, the first data from the output buffer and a subset of the warped data of the at least one component to the output buffer, wherein the subset of the warped data corresponds to the set of coordinates; and writing the composited data to the output buffer.
Aspect 11 may be combined with any of aspects 1-10 and comprises that determining whether the predicted set of boundary coordinates overlaps with the at least one component boundary included in the table comprises: determine whether the predicted set of boundary coordinates is within or on the at least one component boundary or outside of the at least one component boundary.
Aspect 12 may be combined with any of aspects 1-11 and further comprises obtaining the pose information prior to the prediction of the enclosing boundary information of the at least one component.
Aspect 13 may be combined with any of aspects 1-12 and further comprises outputting an indication of the predicted set of boundary coordinates of the at least one component.
Aspect 14 may be combined with any of aspects 1-13 and comprises that the at least one component comprises at least one first component and at least one second component, wherein the metadata comprises predicted depth boundary information associated with the at least one component, the method further comprising: determining, based on the predicted depth boundary information, an overlapping order for the at least one first component and the at least one second component, wherein processing the data is based on the overlapping order.
Aspect 15 may be combined with aspect 14 and comprises that determining the overlapping order for the at least one first component and the at least one second component comprises determining, based on the predicted depth boundary information, that a first depth boundary of the at least one first component does not intersect with a second depth boundary of the at least one second component; and adjusting, based on the predicted depth boundary information, the overlapping order based on an increasing or a decreasing order associated with the predicted depth boundary information.
Aspect 16 may be combined with any of aspects 1-15 and comprises that the composition engine is associated with a table, wherein the table comprises at least one of: a type of at least one first component corresponding to the at least one component boundary, an indication of an overlapping order of the at least one first component, or at least one attribute of the at least one first component, and wherein processing the data of the at least one component is further based on at least one of: the type of the at least one first component, the at least one component boundary of the at least one first component, the indication of the overlapping order of the at least one first component, or the at least one attribute of the at least one first component.
Aspect 17 may be combined with any of aspects 1-16 and comprises that the predicted set of boundary coordinates is included in a list, and wherein adjusting the order of the predicted set of boundary coordinates comprises: sort the list based on an ascending or a descending order of at least one of: a y-coordinate of boundary points associated with the at least one component or an x-coordinate of the boundary points associated with the at least one component.
Aspect 18 may be combined with any of aspects 1-17 and further comprises updating, subsequent to the processing and based on the determination, a table associated with the composition engine.
Aspect 19 may be combined with aspect 18 and comprises that updating the table comprises: adding, based on completion of a composition of the at least one component, at least a portion of the metadata to the table.
Aspect 20 may be combined with aspect 18 and comprises that updating the table comprises: merging the predicted set of boundary coordinates and the at least one component boundary into a single component boundary in the table.
Aspect 21 may be combined with aspect 18 and comprises that updating the table comprises: removing, based on a first-in-first-out (FIFO) data structure, the at least one component boundary of from the table based on the at least one component boundary not overlapping with the predicted set of boundary coordinates.
Aspect 22 may be combined with any of aspects 1-21 and comprises that the data of the at least one component of the at least one frame comprises one of color information or gray scale information.
Aspect 23 may be combined with aspect 22 and comprises that the data of the at least one component of the at least one frame further comprises at least one of: depth information of the at least one component, or an alpha level of the at least one component.
Aspect 24 may be combined with any of aspects 1-23 and comprises that the metadata of the at least one component of the at least one frame comprises at least one of: a depth indication of the at least one component, a depth boundary of the at least one component, an indication of alpha information of the at least one component, a component type of the at least one component, or composition criteria.
Aspect 25 may be combined with any of aspects 1-24 and comprises that obtaining the at least one frame comprising the at least one component comprises: rendering, on a graphics processor, the at least one component of the at least one frame and the metadata of the at least one component of the at least one frame.
Aspect 26 may be combined with any of aspects 1-24 and comprises that obtaining the at least one frame comprising the at least one component comprises: receiving, over a wireless connection, the at least one frame; decoding the at least one frame; and extracting, based on the decoded at least one frame, the at least one component.
Aspect 27 is an apparatus for display processing comprising a processor coupled to a memory, and based on information stored in the memory, the processor is configured to implement a method as in any of aspects 1-26.

Aspect 28 may be combined with aspect 27 and comprises that the apparatus is a wireless communication device comprising at least one of a transceiver or an antenna coupled to the processor, wherein to receive the at least one frame, the processor is configured to receive the at least one frame via at least one of the transceiver or the antenna.
Aspect 29 is an apparatus for display processing comprising means for implementing a method as in any of aspects 1-26.
Aspect 30 is a computer-readable medium (e.g., a non-transitory computer-readable medium) storing computer executable code for display processing, the computer executable code, when executed by a processor, causes the processor to implement a method as in any of aspects 1-26.
Aspect 31 is a method of display processing, including: calculating at least one of (1) a sparsity of rendered content or (2) a sparsity of a predicted composition associated with the rendered content; selecting, based on the calculation, an adaptive reprojection mode from amongst a plurality of adaptive reprojection modes; processing the rendered content based on the selected adaptive reprojection mode; and outputting an indication of the processed rendered content.
Aspect 32 may be combined with aspect 31, wherein each of the plurality of adaptive reprojection modes includes a warping process and a composition process.
Aspect 33 may be combined with aspect 32, wherein the warping process is one of a sparse warp process or a full screen warp process, and wherein the composition process is one of a sparse composition process or a full screen composition process.
Aspect 34 may be combined with any of aspects 32-33, wherein the warping process is associated with a first sparsity level of a plurality of sparsity levels, and wherein the composition process is associated with a second sparsity level of the plurality of sparsity levels.
Aspect 35 may be combined with any of aspects 31-34, wherein processing the rendered content based on the selected adaptive reprojection mode includes executing an image warp on the rendered content, wherein the image warp is associated with the selected adaptive reprojection mode.
Aspect 36 may be combined with any of aspects 31-35, wherein outputting the indication of the processed rendered content includes storing the indication of the processed rendered content in the memory, a buffer, or a cache.
Aspect 37 may be combined with any of aspects 31-36, wherein outputting the indication of the processed rendered content includes transmitting the processed rendered content for display on at least one display panel.
Aspect 38 may be combined with any of aspects 31-37, wherein calculating at least one of (1) the sparsity of the rendered content or (2) the sparsity of the predicted composition associated with the rendered content includes computing a percentage of a display panel that is to be occupied by the rendered content, and wherein selecting the adaptive reprojection mode includes to selecting the adaptive reprojection mode based on the computed percentage and a threshold display percentage.
Aspect 39 may be combined with any of aspects 31-38, wherein each of the plurality of adaptive reprojection modes is associated with a different hardware block of a wearable display device.
Aspect 40 may be combined with any of aspects 31-39, wherein a first adaptive reprojection mode in the plurality of adaptive reprojection modes is associated with a first power consumption, and wherein a second adaptive reprojection mode in the plurality of adaptive reprojection modes is associated with a second power consumption that is different from the first power consumption.
Aspect 41 may be combined with aspect 40, wherein the first power consumption is based on a number of pixels that are reprojected, and wherein the second power consumption is not based on the number of pixels that are reprojected.
Aspect 42 may be combined with aspect 40, wherein the first power consumption and the second power consumption are based on a number of pixels that are reprojected, wherein, for a first sparsity level, the first power consumption is less than the second power consumption, and wherein, for a second sparsity level, the first power consumption is greater than the second power consumption.
Aspect 43 may be combined with any of aspects 31-42, wherein calculating at least one of (1) the sparsity of the rendered content or (2) the sparsity of the predicted composition associated with the rendered content includes determining at least one of a location of the rendered content on a display panel or a size of the rendered content on the display panel, and wherein selecting the adaptive reprojection mode selecting the adaptive reprojection mode based on at least one of the location of the rendered content on the display panel or the size of the rendered content on the display panel.
Aspect 44 may be combined with any of aspects 31-43, wherein the rendered content includes a first rendered frame for a right eye of a user and a second rendered frame for a left eye of the user, and wherein processing the rendered content based on the selected adaptive reprojection mode includes processing the first rendered frame and the second rendered frame based on the selected adaptive reprojection mode.
Aspect 45 may be combined with any of aspects 31-44, further including: receiving, from a companion device, the rendered content, wherein the calculation is based on the received rendered content.
Aspect 46 may be combined with any of aspects 31-44, further including: locally rendering the rendered content prior to the calculation, wherein the calculation is based on the locally rendered content.
Aspect 47 may be combined with any of aspects 31-46, further including: obtaining pose information of a wearable display device, wherein processing the rendered content based on the selected adaptive reprojection mode includes processing the rendered content further based on the pose information.
Aspect 48 may be combined with any of aspects 31-47, wherein the rendered content is at least one of: rendered extended reality (XR), rendered augmented reality (AR) content, rendered mixed reality (MR) content, or rendered virtual reality (VR) content.
Aspect 49 is an apparatus for display processing comprising a processor coupled to a memory, and based on information stored in the memory, the processor is configured to implement a method as in any of aspects 31-48.
Aspect 50 may be combined with aspect 49 and comprises that the apparatus is a wireless communication device comprising at least one of a transceiver or an antenna coupled to the processor, wherein to receive the rendered content, the processor is configured receive the rendered content via at least one of the transceiver or the antenna.
Aspect 51 is an apparatus for display processing comprising means for implementing a method as in any of aspects 31-48.
Aspect 52 is a computer-readable medium (e.g., a non-transitory computer-readable medium) storing computer executable code for display processing, the computer executable code, when executed by a processor, causes the processor to implement a method as in any of aspects 31-48.

The following aspects are illustrative only and may be combined with other aspects or teachings described herein, without limitation.

What is claimed is:

1. An apparatus for display processing, comprising:
a memory; and
a processor coupled to the memory and, based on information stored in the memory, the processor is configured to:
obtain at least one frame comprising at least one component, wherein the at least one component comprises (1) data of the at least one component and (2) metadata of the at least one component, and wherein the metadata includes enclosing boundary information of the at least one component;
predict, based on the enclosing boundary information of the at least one component and pose information from a headset worn by a user corresponding to the at least one component, a set of boundary coordinates of the at least one component;
adjust, based on a display order, an order of the predicted set of boundary coordinates of the at least one component;
determine whether the predicted set of boundary coordinates overlaps with at least one component boundary associated with a composition engine; and
process, based on the determination, the data of the at least one component.

2. The apparatus of claim 1, wherein the processor is further configured to:
store the data of the at least one component and the metadata of the at least one component in at least one of a second memory, a cache, or a component buffer.

3. The apparatus of claim 1, wherein to predict the set of boundary coordinates, the processor is configured to warp the metadata of the at least one component based on the pose information, and wherein to determine whether the predicted set of boundary coordinates overlaps with the at least one component boundary, the processor is configured to determine whether the warped metadata overlaps with the at least one component boundary.

4. The apparatus of claim 3, wherein to warp the metadata of the at least one component, the processor is further configured to warp the metadata of the at least one component additionally based on display parameters.

5. The apparatus of claim 3, wherein the metadata further includes depth boundary information of the at least one component, wherein to warp the metadata based on the pose information, the processor is configured to:
reproject, based on the pose information, the enclosing boundary information and the depth boundary information; and
transform, based on the reprojected enclosing boundary information and the reprojected depth boundary information, the set of boundary coordinates to an enclosing polygon boundary.

6. The apparatus of claim 5, wherein the processor is further configured to:
store, in a first memory or a cache, an indication of the enclosing polygon boundary.

7. The apparatus of claim 3, wherein the processor is further configured to:
warp the data of the at least one component based on the warped metadata of the at least one component and the pose information, and wherein to process the data of the at least one component, the processor is configured to process the warped data of the at least one component.

8. The apparatus of claim 7, wherein the processor is further configured to:
output, for the composition engine, an indication that the data of the at least one component has been warped.

9. The apparatus of claim 7, wherein to process the warped data of the at least one component, the processor is configured to:
transfer, based on a first determination that a set of coordinates of the warped data of the at least one component does not overlap with the at least one component boundary of the at least one first component, a subset of the warped data of the at least one component to an output buffer, wherein the subset of the warped data corresponds to the set of coordinates.

10. The apparatus of claim 7, wherein to process the warped data of the at least one component, the processor is configured to:
read, based on a first determination that a set of coordinates of the warped data of the at least one component overlaps with the at least one component boundary, first data from an output buffer corresponding to an overlapping portion of the set of coordinates;
composite, based on composition criteria, the first data from the output buffer and a subset of the warped data of the at least one component to the output buffer, wherein the subset of the warped data corresponds to the set of coordinates; and
write the composited data to the output buffer.

11. The apparatus of claim 1, wherein to determine whether the predicted set of boundary coordinates overlaps with the at least one component boundary, the processor is configured to:
determine whether the predicted set of boundary coordinates is within or on the at least one component boundary or outside of the at least one component boundary.

12. The apparatus of claim 1, wherein the processor is further configured to:
obtain the pose information prior to the prediction of the enclosing boundary information of the at least one component.

13. The apparatus of claim 1, wherein the processor is further configured to:
output an indication of the predicted set of boundary coordinates of the at least one component.

14. The apparatus of claim 1, wherein the at least one component comprises at least one first component and at least one second component, wherein the metadata comprises predicted depth boundary information associated with the at least one component, wherein the processor is further configured to:
determine, based on the predicted depth boundary information, an overlapping order for the at least one first component and the at least one second component, wherein to process the data of the at least one component, the processor is configured to process the data based on the overlapping order.

15. The apparatus of claim 14, wherein to determine the overlapping order for the at least one first component and the at least one second component, the processor is configured to:
determine, based on the predicted depth boundary information, that a first depth boundary of the at least one first component does not intersect with a second depth boundary of the at least one second component; and
adjust, based on the predicted depth boundary information, the overlapping order based on an increasing or a decreasing order associated with the predicted depth boundary information.

16. The apparatus of claim 1, wherein the composition engine is associated with a table, wherein the table includes at least one of: a type of at least one first component corresponding to the at least one component boundary, an indication of an overlapping order of the at least one first component, or at least one attribute of the at least one first component, and wherein to process the data of the at least one component, the processor is configured to process the data of the at least one component based on at least one of: the type of the at least one first component, the at least one component boundary of the at least one first component, the indication of the overlapping order of the at least one first component, or the at least one attribute of the at least one first component.

17. The apparatus of claim 1, wherein the predicted set of boundary coordinates is included in a list, and wherein to adjust the order of the predicted set of boundary coordinates, the processor is configured to:
sort the list based on an ascending or a descending order of at least one of: a y-coordinate of boundary points associated with the at least one component or an x-coordinate of the boundary points associated with the at least one component.

18. The apparatus of claim 1, wherein the apparatus is a wireless communication device comprising at least one of a transceiver or an antenna coupled to the processor, and wherein to obtain the at least one frame, the processor is configured to obtain the at least one frame via at least one of the transceiver or the antenna.

19. A method of display processing, comprising:
obtaining at least one frame comprising at least one component, wherein the at least one component comprises (1) data of the at least one component and (2) metadata of the at least one component, and wherein the metadata includes enclosing boundary information of the at least one component;
predicting, based on the enclosing boundary information of the at least one component and pose information from a headset worn by a user corresponding to the at least one component, a set of boundary coordinates of the at least one component;
adjusting, based on a display order, an order of the predicted set of boundary coordinates of the at least one component;
determining whether the predicted set of boundary coordinates overlaps with at least one component boundary associated with a composition engine; and
processing, based on the determination, the data of the at least one component.

20. A computer-readable medium storing computer executable code for display processing, the computer executable code, when executed by a processor, causes the processor to:
obtain at least one frame comprising at least one component, wherein the at least one component comprises (1) data of the at least one component and (2) metadata of the at least one component, and wherein the metadata includes enclosing boundary information of the at least one component;
predict, based on the enclosing boundary information of the at least one component and pose information from a headset worn by a user corresponding to the at least one component, a set of boundary coordinates of the at least one component;
adjust, based on a display order, an order of the predicted set of boundary coordinates of the at least one component;
determine whether the predicted set of boundary coordinates overlaps with at least one component boundary associated with a composition engine; and
process, based on the determination, the data of the at least one component.
